(19) United States
(12) Patent Application Publication
(10) Pub. No.: US 2024/0199048 A1
(43) Pub. Date: Jun. 20, 2024

(54) PARKING MANAGEMENT FOR AUTONOMOUS VEHICLES THROUGH AUGMENTED REALITY

(71) Applicant: International Business Machines Corporation, Armonk, NY (US)

(72) Inventors: Jennifer M. Hatfield, San Francisco, CA (US); Jeremy R. Fox, Georgetown, TX (US); Tushar Agrawal, West Fargo, ND (US); Sarbajit K. Rakshit, Kolkata (IN)

(21) Appl. No.: 18/065,831

(22) Filed: Dec. 14, 2022

(51) Int. Cl. B60W 50/14; B60W 30/06; B60W 60/00; G08G 1/14

(52) U.S. Cl. CPC B60W 50/14; B60W 30/06; B60W 60/001; G08G 1/141; B60W 2050/146

(57) ABSTRACT

A computer system, computer program product, and computer-implemented method for using augmented reality (AR) to enhance parking of autonomous vehicles. The method includes capturing, through one or more sensors, the physical characteristics of a parking facility, and identifying, through the one or more sensors, the physical characteristics of vehicles therein. The method also includes generating, subject to the capturing and identifying, an augmented reality (AR) representation of the parking facility and the vehicles. The method further includes presenting, through a display device, the AR representation of the parking facility and the vehicles. The method also includes receiving, subject to the presenting, potential parking locations at least partially based on presently vacant parking locations indicated within the AR representation of the parking facility and the vehicles. The method further includes parking, subject to the receiving, autonomous vehicles within selected parking locations of the potential parking locations.

### BACKGROUND

The present disclosure relates to enhancing operation of autonomous vehicles, and, more specifically, toward using augmented reality to enhance parking of autonomous vehicles.

Many known vehicular transportation systems use one or more of augmented reality and autonomous vehicle driving features in collaboration with each other to define an autonomous vehicle system. For example, some known autonomous vehicle systems facilitate analyzing the surrounding traffic and thoroughfare conditions in real time and making driving decisions while the vehicle is autonomously driving through the traffic along the throughfare, i.e., with little to no human support. In addition, at least some of these known autonomous vehicle systems are configured to exchange the real time information through a networked architecture. Moreover, the networked autonomous vehicle systems are configured to exchange relevant information of each vehicle in the network. Such networked autonomous vehicle systems are also configured to share next actions and accordingly the vehicles are making and sharing collaborative driving decisions.

### SUMMARY

A system, product, and method are provided for using augmented reality to enhance parking of autonomous vehicles.

In one aspect, a computer system for using augmented reality (AR) to enhance parking of autonomous vehicles is presented. The system includes one or more processing devices and one or more memory devices communicatively and operably coupled to the one or more processing devices. The system also includes an autonomous vehicles parking manager communicatively and operably coupled to the one or more processing devices. The system further includes one or more sensors communicatively and operably coupled to the autonomous vehicles parking manager and a display device communicatively and operably coupled to the autonomous vehicles parking manager. The system also includes one or more augmented reality (AR) devices communicatively and operably coupled to the autonomous vehicles parking manager. The autonomous vehicles parking manager is configured to capture, through the one or more sensors, at least a portion of the physical characteristics of a parking facility, and identify, through the one or more sensors, at least a portion of the physical characteristics of at least a portion of first vehicles within the at least a portion of the parking facility. The autonomous vehicles parking manager is also configured to generate, subject to the capturing and identifying, an AR representation of the at least a portion of the parking facility and the at least a portion of the first vehicles. The autonomous vehicles parking manager is further configured to present, through the display device, the AR representation of the at least a portion of the parking facility and the at least a portion of the first vehicles. The autonomous vehicles parking manager is also configured to receive, subject to the presenting, one or more potential parking locations at least partially based on presently vacant parking locations indicated within the AR representation of the at least a portion of the parking facility and the at least a portion of the first vehicles. The autonomous vehicles parking manager is further configured to park, subject to the receiving, one or more autonomous vehicles within one or more selected parking locations of the one or more potential parking locations.

In another aspect, a computer program product is presented. The product includes one or more computer readable storage media and program instructions collectively stored on the one or more computer storage media. The program instructions include program instructions to execute one or more operations for using augmented reality to enhance parking of autonomous vehicles. The program instructions further include program instructions to capture, through one or more sensors, at least a portion of the physical characteristics of a parking facility, and program instructions to identify, through the one or more sensors, at least a portion of the physical characteristics of at least a portion of first vehicles within the at least a portion of the parking facility. The program instructions also include program instructions to generate, subject to the capturing and identifying, an augmented reality (AR) representation of the at least a portion of the parking facility and the at least a portion of the first vehicles. The program instructions further include program instructions to present, through a display device, the AR representation of the at least a portion of the parking facility and the at least a portion of the first vehicles. The program instructions also include program instructions to receive, subject to the presenting, one or more potential parking locations at least partially based on presently vacant parking locations indicated within the AR representation of the at least a portion of the parking facility and the at least a portion of the first vehicles. The program instructions further include program instructions to park, subject to the receiving, one or more autonomous vehicles within one or more selected parking locations of the one or more potential parking locations.

In yet another aspect, a computer-implemented method for using augmented reality to enhance parking of autonomous vehicles is presented is presented. The method includes capturing, through one or more sensors, at least a portion of the physical characteristics of a parking facility, and identifying, through the one or more sensors, at least a portion of the physical characteristics of at least a portion of first vehicles within the at least a portion of the parking facility. The method also includes generating, subject to the capturing and identifying, an augmented reality (AR) representation of the at least a portion of the parking facility and the at least a portion of the first vehicles. The method also includes presenting, through a display device, the AR representation of the at least a portion of the parking facility and the at least a portion of the first vehicles. The method further includes receiving, subject to the presenting, one or more potential parking locations at least partially based on presently vacant parking locations indicated within the AR representation of the at least a portion of the parking facility and the at least a portion of the first vehicles. The method also includes parking, subject to the receiving, one or more autonomous vehicles within one or more selected parking locations of the one or more potential parking locations.

The present Summary is not intended to illustrate each aspect of every implementation of, and/or every embodiment of the present disclosure. These and other features and advantages will become apparent from the following detailed description of the present embodiment(s), taken in conjunction with the accompanying drawings.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are illustrative of certain embodiments and do not limit the disclosure.

FIG. 1A is a block schematic diagram illustrating a computer system including an artificial intelligence platform suitable for leveraging a trained cognitive system to facilitate using augmented reality to enhance parking of autonomous vehicles, in accordance with some embodiments of the present disclosure.

FIG. 1B is a block schematic diagram illustrating the artificial intelligence platform shown in FIG. 1A, in accordance with some embodiments of the present disclosure.

FIG. 1C is a continuation of the artificial intelligence platform from FIG. 1B, in accordance with some embodiments of the present disclosure.

FIG. 1D is a block schematic diagram illustrating a data library shown in FIG. 1A, in accordance with some embodiments of the present disclosure.

FIG. 2 is a block schematic diagram illustrating one or more artificial intelligence platform tools, as shown and described with respect to FIGS. 1A-1D, and their associated application program interfaces, in accordance with some embodiments of the present disclosure.

FIG. 3 is a schematic diagram illustrating portions of the system with respect to FIGS. 1A-1D in a simplified configuration, in accordance with some embodiments of the present disclosure.

FIG. 4A is a schematic cutaway diagram illustrating a portion of a parking facility, in accordance with some embodiments of the present disclosure.

FIG. 4B is a schematic overhead diagram illustrating a portion of the parking facility presented in FIG. 4A, in accordance with some embodiments of the present disclosure.

FIG. 4C is a schematic overhead diagram illustrating a portion of the parking facility presented in FIGS. 4A and 4B, in accordance with some embodiments of the present disclosure.

FIG. 5A is a flowchart illustrating a process for using augmented reality to enhance parking of autonomous vehicles, in accordance with some embodiments of the present disclosure.

FIG. 5B is a continuation of the flowchart presented in FIG. 5A, in accordance with some embodiments of the present disclosure.

FIG. 5C is a continuation of the flowchart presented in FIGS. 5A and 5B, in accordance with some embodiments of the present disclosure.

FIG. 6 is as block schematic diagram illustrating an example of a computing environment for the execution of at least some of the computer code involved in performing the disclosed methods described herein, in accordance with some embodiments of the present disclosure.

While the present disclosure is amenable to various modifications and alternative forms, specifics thereof have been shown by way of example in the drawings and will be described in detail. It should be understood, however, that the intention is not to limit the present disclosure to the particular embodiments described. On the contrary, the intention is to cover all modifications, equivalents, and alternatives falling within the spirit and scope of the present disclosure.

### DETAILED DESCRIPTION

Aspects of the present disclosure relate to for using augmented reality to enhance to enhance parking of autonomous vehicles. While the present disclosure is not necessarily limited to such applications, various aspects of the disclosure may be appreciated through a discussion of various examples using this context.

It will be readily understood that the components of the present embodiments, as generally described and illustrated in the Figures herein, may be arranged and designed in a wide variety of different configurations. Thus, the following detailed description of the embodiments of the apparatus, system, method, and computer program product of the present embodiments, as presented in the Figures, is not intended to limit the scope of the embodiments, as claimed, but is merely representative of selected embodiments.

Reference throughout this specification to “a select embodiment,” “at least one embodiment,” “one embodiment,” “another embodiment,” “other embodiments,” or “an embodiment” and similar language means that a particular feature, structure, or characteristic described in connection with the embodiment is included in at least one embodiment. Thus, appearances of the phrases “a select embodiment,” “at least one embodiment,” “in one embodiment,” “another embodiment,” “other embodiments,” or “an embodiment” in various places throughout this specification are not necessarily referring to the same embodiment.

The illustrated embodiments will be best understood by reference to the drawings, wherein like parts are designated by like numerals throughout. The following description is intended only by way of example, and simply illustrates certain selected embodiments of devices, systems, and processes that are consistent with the embodiments as claimed herein.

As used herein, “facilitating” an action includes performing the action, making the action easier, helping to carry the action out, or causing the action to be performed. Thus, by way of example and not limitation, instructions executing on one processor might facilitate an action carried out by semiconductor processing equipment, by sending appropriate data or commands to cause or aid the action to be performed. Where an actor facilitates an action by other than performing the action, the action is nevertheless performed by some entity or combination of entities.

Many known vehicular transportation systems use one or more of augmented reality and autonomous vehicle driving features in collaboration with each other to define an autonomous vehicle system. For example, some known autonomous vehicle systems facilitate analyzing the surrounding traffic and thoroughfare conditions in real time and making driving decisions while the vehicle is autonomously driving through the traffic along the throughfare. i.e., with little to no human support. In addition, at least some of these known autonomous vehicle systems are configured to exchange the real time information through a networked architecture. Moreover, the networked autonomous vehicle systems are configured to exchange relevant information of each vehicle in the network. Such networked autonomous vehicle systems are also configured to share next actions and accordingly the vehicles are making and sharing collaborative driving decisions.

In addition, for vehicle parking activities, some of the known vehicular transportation systems for autonomous vehicles analyze the surrounding vicinity of a designated parking facility and provide and execute driving decisions, including identifying the correct parking facility, and autonomously driving to the designated parking location. Also, some of the known vehicular transportation systems for autonomous vehicles analyze the surrounding vicinity of a passenger pickup spot associated with the present parking facility and provide and execute driving decisions, including identifying the near-exact pickup location, and autonomously driving to the designated passenger pickup location. Further, many of the known vehicular transportation systems for autonomous vehicles permit local manual operation of the autonomous vehicle by an occupant driver, where the driver takes control of the parking decisions and the execution thereof.

Such known autonomous vehicular transportation systems for autonomous vehicles are not configured for selecting the most appropriate parking facility and the user will determine the parking facility. Therefore, in many instances, if the parking spot is not yet determined at the time of entry into the parking facility, the driver of the vehicle will typically navigate through the parking facility and select the first available parking space that seems most appropriate. However, it is typically convenient to drop the occupants off at one location separate from the parking location, either within the parking facility or external to the parking facility, i.e., at an entrance to a sporting or other entertainment venue. An inconvenience to the driver is presented since the vehicle will need to be driven to the parking space, whether previously assigned or not, and the driver will make the trek back to the occupant unloading area. The issue is amplified if there are multiple vehicles for a group, therefore there being multiple drivers that will need to park their respective vehicles. In addition, each of the respective vehicles needs to be retrieved by the respective drives. Accordingly, extending the autonomous vehicles' capabilities to autonomous, or semi-autonomous parking activities will more effectively and efficiently position the multiple vehicles within the determined parking spaces.

Systems, computer program products, and methods are disclosed and described herein for enhancing operation of autonomous vehicles, and, more specifically, toward using augmented reality to enhance parking of autonomous vehicles. Such operational enhancements include, without limitation, facilitating collaboration between other autonomous vehicles and augmented reality to project a digital model of the respective parking facility with proximate surroundings and spaces that are available to park vehicles. The systems, computer program products, and methods further permit a user to choose an appropriate parking spot within the AR interface to park their vehicle. The AR interface considers business rules for parking e.g., handicap parking spots, reserved spots, parking spots with a time limit, etc., based on the user's contextual situation. In addition, the systems described herein use the computer program products and methods described herein to learn the user's preferences and recommends parking spots based on the preferences, e.g., near an elevator. The system further facilitates the users to specify an occupant pickup point and facilitate collaboration with the other autonomous vehicles and proximate surroundings to reduce any potential for damage as the vehicle leaves the parking spot and drives itself towards the occupant pickup spot.

The terms “operator,” “operators,” “driver,” and “drivers” are used interchangeably herein. The systems, computer program products, and methods disclosed herein integrate artificial intelligence, machine learning features, simulation, augmented reality, and aspects of virtual reality.

In at least some embodiments, the systems, computer program products, and methods described herein employ a targeted AR overlay of the entire parking facility. Specifically, while parking any vehicle in any parking facility, the systems described herein use an augmented reality system to show the digital model of the entire parking facility and associated surroundings of the parking facility along with real time positions of other vehicles in advance. Accordingly, the user can choose an appropriate parking spot from the augmented reality interface where the user wants the vehicle to be parked.

Also, in at least some embodiments, the systems, computer program products, and methods described herein implement a generating ruleset for the targeted AR overlay for space availability. Specifically, while selecting the required parking spot from the augmented reality user interface of the entire parking facility, the systems described herein use show various rules and regulations of the parking facility, e.g., the user may not select a reserved spot or a handicap spot or a spot with time limit, etc. Accordingly, the user can select the required parking facility and navigate in the augmented reality interface of the parking facility.

Moreover, in at least some embodiments, the systems, computer program products, and methods described herein implement AR overlay with weighting and conflict priority management. Specifically, based on historical selection of types of parking spots and the properties of the parking facility, etc., the systems described herein identify available parking spaces for the vehicle. The system learns user's preferences and recommends spots based on the preference, e.g., near an elevator. The recommended parking space is shown on the augmented reality interface of the entire parking facility and accordingly the user can select the required parking space for the vehicle.

Furthermore, in at least some embodiments, the systems, computer program products, and methods described herein implement AR overlay for pickup way point and routing selection. Specifically, the systems described herein allow the user to specify a pickup point for the autonomous vehicle. In addition, the systems described herein guide the vehicle for the path that should be taken to travel from the parking spot to the pickup point.

Also, in at least some embodiments, the systems, computer program products, and methods described herein implement multiple vehicle AR overlay (call request) selection features. Specifically, based on the requirements, the user selects multiple parking facilities for multiple vehicles (e.g., travelling in a group) or calls multiple vehicles from the parking facility to the pickup location. Accordingly, the user can use the augmented reality interface to book the parking facility and get the vehicles to the pickup location.

Moreover, in at least some embodiments, the systems, computer program products, and methods described herein implement AR overlay for obstacle identification and routing amelioration. Specifically, while the vehicles will be parked or need to come out from the parking facility to pick up the user, the vehicles will collaborate with other vehicles and the parking facility surroundings to find the relative positions of obstacles, etc.

In some embodiments, the systems, computer program products, and methods described herein implement an AR overlay for weather inclusion and avoidance for the current weather conditions based on the current and forecasted weather data from a one or more of the information handling devices 180, or, in some cases, a referenced weather API. In some embodiments, overhead coverage selection features reference user's has profile preference to park their vehicle away from inclement weather, e.g., rain, as they have an open load within a pickup truck and the rain may cause damage to the load. In addition, some user's may not want covered parking for predetermined reasons. In some embodiments, pooling water on ground avoidance features are available, where the user wants to avoid locations of pooling water on the ground near any water drains. Moreover, in some embodiments, winter snow and ice avoidance features are available, where, based on the weather forecast, if there is a more protected parking facility or space, the user has the ability to select a preferred area for parking locations based on inclement weather events.

In at least some embodiments, the information used to facilitate collaboration between the vehicles includes leveraging Internet of Things (IoT) techniques including, but not limited to, vehicle-to-vehicle (V2V) and vehicle-to-infrastructure (V2I) communication techniques.

In at least some embodiments, the system, computer program product, and method described herein use an artificial intelligence platform. “Artificial Intelligence” (AI) is one example of cognitive systems that relate to the field of computer science directed at computers and computer behavior as related to humans and man-made and natural systems. Cognitive computing utilizes self-teaching algorithms that use, for example, and without limitation, data analysis, visual recognition, behavioral monitoring, and natural language processing (NLP) to solve problems and optimize human processes. The data analysis and behavioral monitoring features analyze the collected relevant data and behaviors as subject matter data as received from the sources as discussed herein. As the subject matter data is received, organized, and stored, the data analysis and behavioral monitoring features analyze the data and behaviors to determine the relevant details through computational analytical tools which allow the associated systems to learn, analyze, and understand human behavior, including within the context of the present disclosure. With such an understanding, the AI can surface concepts and categories, and apply the acquired knowledge to teach the AI platform the relevant portions of the received data and behaviors. In addition to analyzing human behaviors and data, the AI platform may also be taught to analyze data and behaviors of man-made and natural systems.

In addition, cognitive systems such as AI, based on information, are able to make decisions, which maximizes the chance of success in a given topic. More specifically, AI is able to learn from a dataset, including behavioral data, to solve problems and provide relevant recommendations. For example, in the field of artificial intelligent computer systems, machine learning (ML) systems process large volumes of data, seemingly related or unrelated, where the ML systems may be trained with data derived from a database or corpus of knowledge, as well as recorded behavioral data. The ML systems look for, and determine, patterns, or lack thereof, in the data, “learn” from the patterns in the data, and ultimately accomplish tasks without being given specific instructions. In addition, the ML systems, utilizes algorithms, represented as machine processable models, to learn from the data and create foresights based on this data. More specifically, ML is the application of AI, such as, and without limitation, through creation of neural networks that can demonstrate learning behavior by performing tasks that are not explicitly programmed. Deep learning is a type of neural-network ML in which systems can accomplish complex tasks by using multiple layers of choices based on output of a previous layer, creating increasingly smarter and more abstract conclusions.

ML learning systems may have different “learning styles.” One such learning style is supervised learning, where the data is labeled to train the ML system through telling the ML system what the key characteristics of a thing are with respect to its features, and what that thing actually is. If the thing is an object or a condition, the training process is called classification. Supervised learning includes determining a difference between generated predictions of the classification labels and the actual labels, and then minimize that difference. If the thing is a number, the training process is called regression. Accordingly, supervised learning specializes in predicting the future.

A second learning style is unsupervised learning, where commonalities and patterns in the input data are determined by the ML system through little to no assistance by humans. Most unsupervised learning focuses on clustering, i.e., grouping the data by some set of characteristics or features. These may be the same features used in supervised learning, although unsupervised learning typically does not use labeled data. Accordingly, unsupervised learning may be used to find outliers and anomalies in a dataset, and cluster the data into several categories based on the discovered features.

Semi-supervised learning is a hybrid of supervised and unsupervised learning that includes using labeled as well as unlabeled data to perform certain learning tasks. Semi-supervised learning permits harnessing the large amounts of unlabeled data available in many use cases in combination with typically smaller sets of labelled data. Semi-supervised classification methods are particularly relevant to scenarios where labelled data is scarce. In those cases, it may be difficult to construct a reliable classifier through either supervised or unsupervised training. This situation occurs in application domains where labelled data is expensive or difficult obtain, like computer-aided diagnosis, drug discovery and part-of-speech tagging. If sufficient unlabeled data is available and under certain assumptions about the distribution of the data, the unlabeled data can help in the construction of a better classifier through classifying unlabeled data as accurately as possible based on the documents that are already labeled.

The third learning style is reinforcement learning, where positive behavior is “rewarded: and negative behavior is “punished.” Reinforcement learning uses an “agent,” the agent's environment, a way for the agent to interact with the environment, and a way for the agent to receive feedback with respect to its actions within the environment. An agent may be anything that can perceive its environment through sensors and act upon that environment through actuators. Therefore, reinforcement learning rewards or punishes the ML system agent to teach the ML system how to most appropriately respond to certain stimuli or environments. Accordingly, over time, this behavior reinforcement facilitates determining the optimal behavior for a particular environment or situation.

Deep learning is a method of machine learning that incorporates neural networks in successive layers to learn from data in an iterative manner. Neural networks are models of the way the nervous system operates. Basic units are referred to as neurons, which are typically organized into layers. The neural network works by simulating a large number of interconnected processing devices that resemble abstract versions of neurons. There are typically three parts in a neural network, including an input layer, with units representing input fields, one or more hidden layers, and an output layer, with a unit or units representing target field(s). The units are connected with varying connection strengths or weights. Input data are presented to the first layer, and values are propagated from each neuron to every neuron in the next layer. At a basic level, each layer of the neural network includes one or more operators or functions operatively coupled to output and input. Output from the operator(s) or function(s) of the last hidden layer is referred to herein as activations. Eventually, a result is delivered from the output layers. Deep learning complex neural networks are designed to emulate how the human brain works, so computers can be trained to support poorly defined abstractions and problems. Therefore, deep learning is used to predict an output given a set of inputs, and either supervised learning or unsupervised learning can be used to facilitate such results.

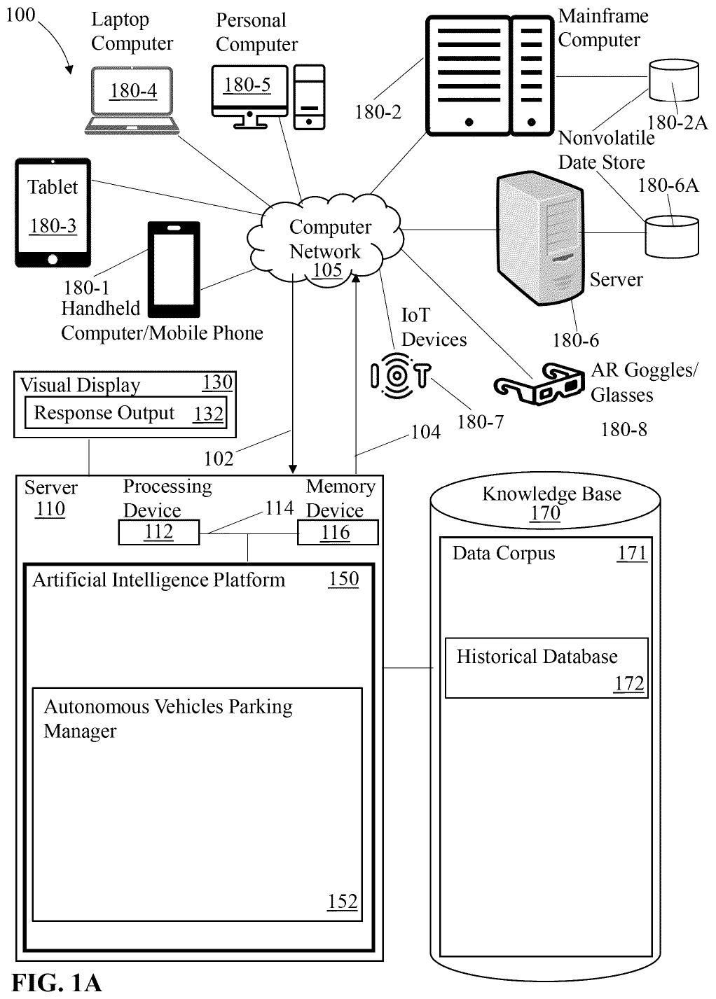

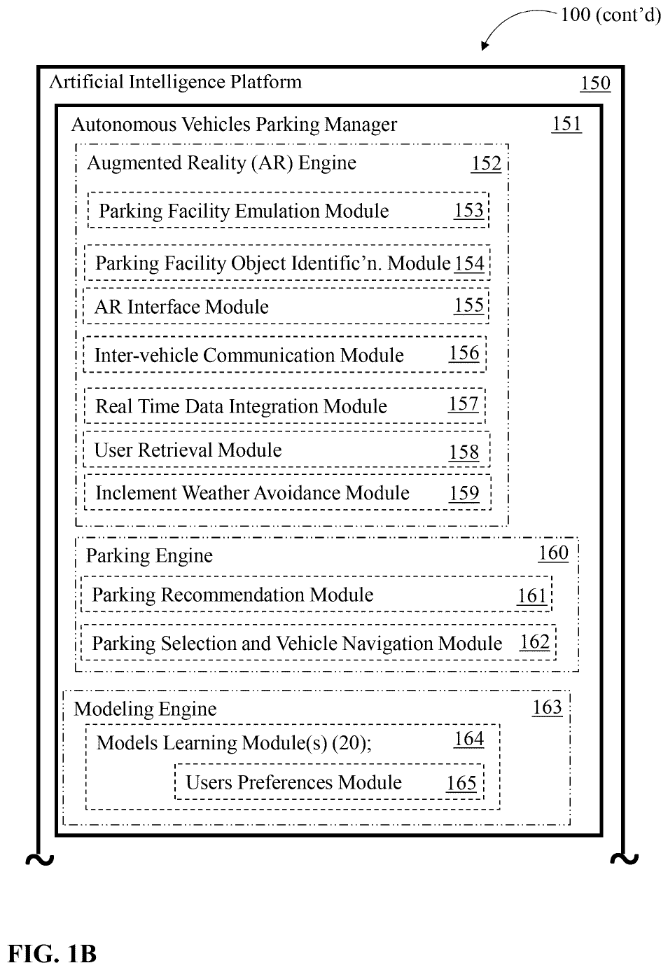

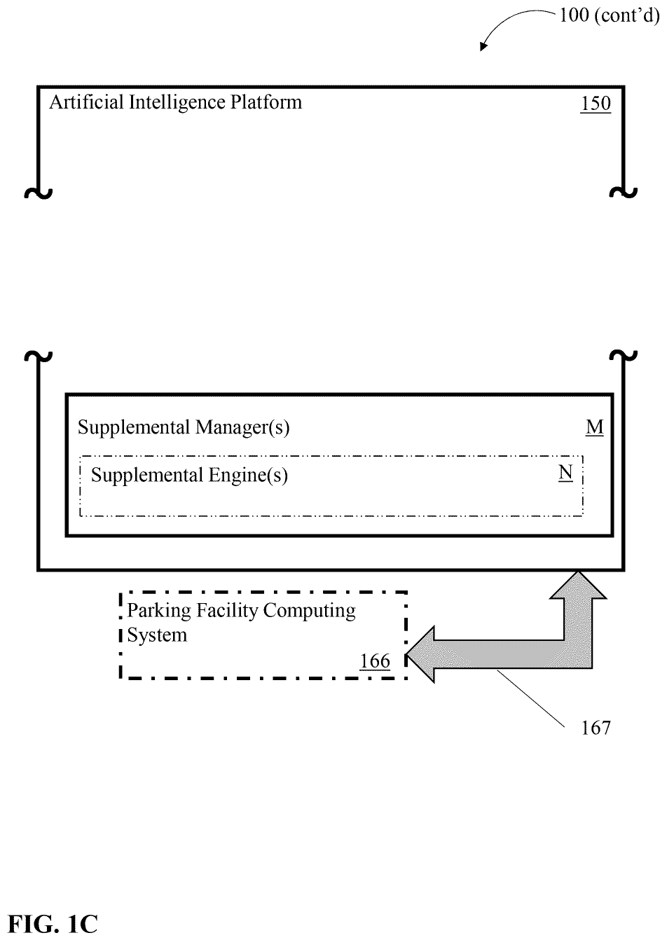

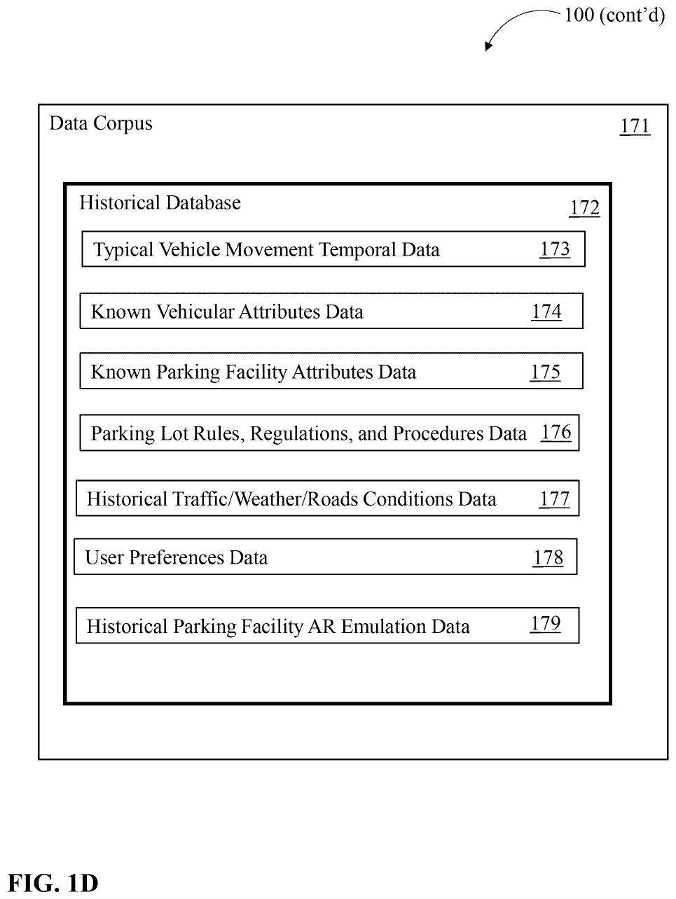

Referring to FIG. 1A, a schematic diagram is provided illustrating a computer system 100, that in the embodiments described herein, is a vehicular information system 100, herein referred to as the system 100. As described further herein, system 100 is configured for enhancing operation of autonomous vehicles, and, more specifically, using augmented reality to enhance parking of autonomous vehicles. Such operational enhancements include, without limitation, automatic collection, generation, and presentation of real time information to vehicular operators, and, more specifically, to automatically and dynamically provide recommendations and insights to the operator of a vehicle with respect to parking the vehicle. In at least one embodiment, the system 100 includes one or more automated machine learning (ML) system features to leverage a trained cognitive system, in corroboration with embedded augmented reality (AR) features to automatically and dynamically provide the aforementioned recommendations and insights to the operators of their respective vehicles. In at least one embodiment, the system 100 is embodied as a cognitive system, i.e., an artificial intelligence (AI) platform computing system that includes an artificial intelligence platform 150 suitable for establishing the environment to facilitate the collection, generation, and presentation of real time information and instructions with respect to parking the respective vehicle.

As shown, a server 110 is provided in communication with a plurality of information handling devices 180 (sometimes referred to as information handling systems, computing devices, and computing systems) across a computer network connection 105. The computer network connection 105 may include several information handling devices 180. Types of information handling devices that can utilize the system 100 range from small handheld devices, such as a handheld computer/mobile telephone 180-1 to large mainframe systems, such as a mainframe computer 180-2. Additional examples of information handling devices include personal digital assistants (PDAs), personal entertainment devices, pen or tablet computer 180-3, laptop or notebook computer 180-4, personal computer system 180-5, server 180-6, one or more Internet of Things (IoT) devices 180-7, that in at least some embodiments, include connected cameras and environmental sensors, and AR glasses or goggles 180-8. As shown, the various information handling devices, collectively referred to as the information handling devices 180, are networked together using the computer network connection 105.

Various types of a computer networks can be used to interconnect the various information handling systems, including Local Area Networks (LANs), Wireless Local Area Networks (WLANs), the Internet, the Public Switched Telephone Network (PSTN), other wireless networks, and any other network topology that can be used to interconnect information handling systems and computing devices as described herein. In at least some embodiments, at least a portion of the network topology includes cloud-based features. Many of the information handling devices 180 include non-volatile data stores, such as hard drives and/or non-volatile memory. Some of the information handling devices 180 may use separate non-volatile data stores, e.g., server 180-6 utilizes non-volatile data store 180-6A, and mainframe computer 180-2 utilizes non-volatile data store 180-2A. The non-volatile data store 180-2A can be a component that is external to the various information handling devices 180 or can be internal to one of the information handling devices 180.

The server 110 is configured with a processing device 112 in communication with memory device 116 across a bus 114. The server 110 is shown with the artificial intelligence (AI) platform 150 for cognitive computing, including machine learning, over the computer network connection 105 from one or more of the information handling devices 180. More specifically, the information handling devices 180 communicate with each other and with other devices or components via one or more wired and/or wireless data communication links, where each communication link may comprise one or more of wires, routers, switches, transmitters, receivers, or the like. In this networked arrangement, the server 110 and the computer network connection 405 enable communication, detection, recognition, and resolution. The server 110 is in operable communication with the computer network through communications links 102 and 104. Links 102 and 104 may be wired or wireless. Other embodiments of the server 110 may be used with components, systems, sub-systems, and/or devices other than those that are depicted herein.

The AI platform 150 is shown herein configured with tools to enable automatic collection, generation, and presentation of real time information to vehicular occupants. More specifically, the AI platform 150 is configured for configured for enhancing operation of autonomous vehicles, and, more specifically, toward using augmented reality to enhance parking of autonomous vehicles. Such operational enhancements include, without limitation, automatic collection, generation, and presentation of real time information to vehicular occupants, and, more specifically, to automatically and dynamically provide recommendations and insights to the operator of a vehicle while travelling therein with respect to parking the vehicle. In one embodiment, one or more high-fidelity machine learning (ML) models of the vehicle operators (drivers), the passengers, and the routes is resident within the AI platform 150. Herein, the terms “model” and “models” includes “one or more models.” Therefore, as a portion of data ingestion by the model, data resident within a knowledge base 170 is injected into the model as described in more detail herein. Accordingly, the AI platform 150 includes a learning-based mechanism that can facilitate training of the model with respect to the drivers and the parking facilitates to facilitate an effective vehicular information system 100.

The tools embedded within the AI platform 150 as shown and described herein include, but are not limited to, an autonomous vehicles parking manager 151 that is described further with respect to FIG. 1B. Referring to FIG. 1B, a block schematic diagram is provided illustrating the AI platform 150 shown in FIG. 1A with greater detail, in accordance with some embodiments of the present disclosure. Continuing to also refer to FIG. 1A, and continuing the numbering sequence thereof, the autonomous vehicles parking manager 151 includes an augmented reality (AR) engine 152 with a parking facility emulation module 153, a parking facility object identification module 154, an AR interface module 155, an inter-vehicle communication module 156, a real time data integration module 157, a user retrieval module 158, and an inclement weather avoidance module 159, all embedded therein.

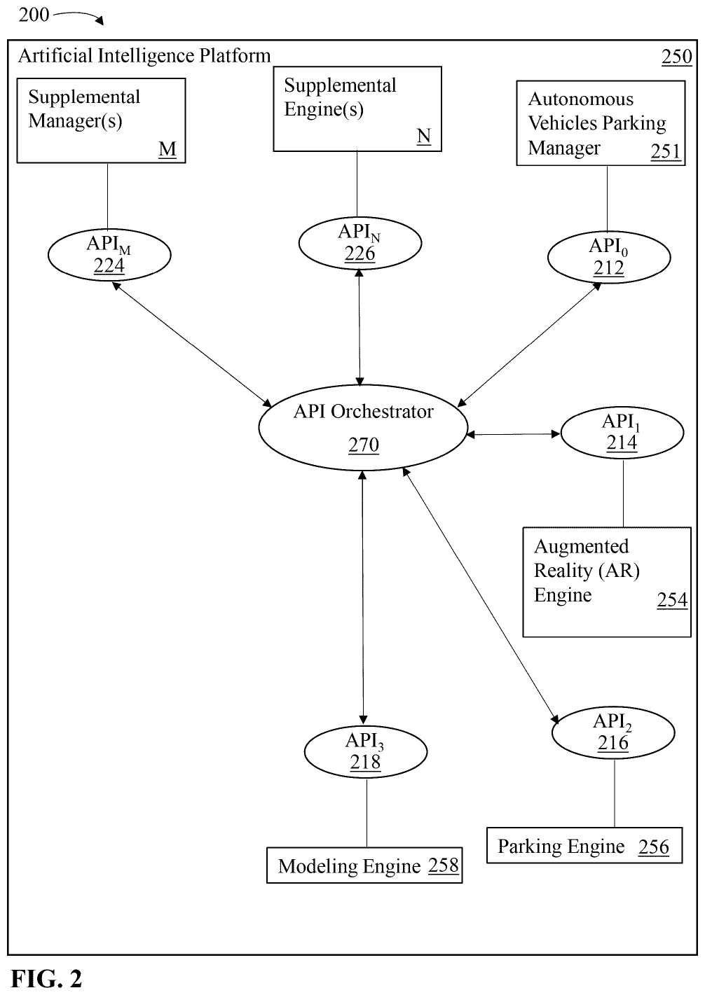

The autonomous vehicles parking manager 151 also includes a parking engine 160 with a parking recommendation module 161 and a parking selection and vehicle navigation module 162 embedded therein. The autonomous vehicles parking manager 151 also includes a modeling engine 163 and an embedded models module 164 that includes, without limitation, the models resident therein. The aforementioned managers and engines are described further herein with respect to FIGS. 2 through 5C.

Referring to FIG. 1C, in some embodiments, the AI platform 150 includes one or more supplemental managers M (only one shown) and one or more supplemental engines N (only one shown) that are employed for any supplemental functionality in addition to the functionality described herein. The one or more supplemental managers M and the one or more supplemental engines N include any number of modules embedded therein to enable the functionality of the respective managers M and engines N.

In one or more embodiments, the artificial intelligence platform 150 is communicatively coupled to a parking facility computing system 166 as indicated by the arrow 167. The two-way communications as indicated by the arrow 167 are discussed further herein.

Referring again to FIG. 1A, the AI platform 150 may receive input from the computer network connection 105 and leverage the knowledge base 170, also referred to herein as a data source, to selectively access training and other data. The knowledge base 170 is communicatively and operably coupled to the server 110 including the processing device 112 and/or memory 116. In at least one embodiment, the knowledge base 170 may be directly communicatively and operably coupled to the server 110. In some embodiments, the knowledge base 170 is communicatively and operably coupled to the server 110 across the computer network connection 105. In at least one embodiment, the knowledge base 170 includes a data corpus 171 that in some embodiments, is referred to as a data repository, a data library, and knowledge corpus, that may be in the form of one or more databases. The data corpus 171 is described further with respect to FIG. 1D.

Referring to FIG. 1D, a block schematic diagram is presented illustrating the data corpus 171 shown in FIG. 1A with greater detail, in accordance with some embodiments of the present disclosure. Continuing to also refer to FIG. 1A, and continuing the numbering sequence thereof, the data corpus 171 includes different databases, including, but not limited to, a historical database 172 that includes, without limitation, typical vehicle movement temporal data 173, known vehicular attributes data 174, known parking facility attributes data 175, parking facility rules, regulations, and procedures data 176, historical traffic/weather/roads conditions data 177, user preferences data 178, and historical parking facility AR emulation data 179. The respective databases and the resident data therein are described further herein with respect to FIGS. 2-5C. Accordingly, the server 110, including the AI platform 150 and the autonomous vehicles parking manager 151, receive information through the computer network connection 105 from the devices connected thereto and the knowledge base 170.

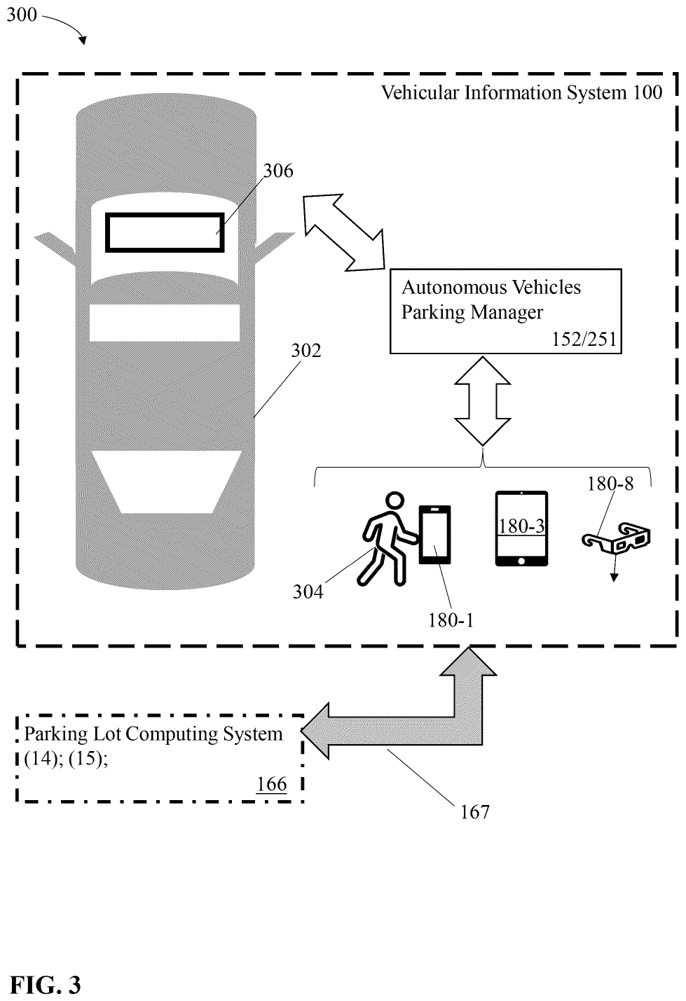

Referring again to FIG. 1A, a response output 132 includes, for example, and without limitation, output generated in response to a query of the data corpus 171 that may include some combination of the datasets resident therein. Further details of the information displayed is described with respect to FIGS. 3-5C.

In at least one embodiment, the response output 132 is communicated to a corresponding network device, shown herein as a visual display 130, communicatively and operably coupled to the server 110 or in at least one other embodiment, operatively coupled to one or more of the computing devices across the computer network connection 105.

The computer network connection 105 may include local network connections and remote connections in various embodiments, such that the artificial intelligence platform 150 may operate in environments of any size, including local and global, e.g., the Internet. Additionally, the AI platform 150 serves as a front-end system that can make available a variety of knowledge extracted from or represented in network accessible sources and/or structured data sources. In this manner, some processes populate the AI platform 150, with the AI platform 150 also including one or more input interfaces or portals to receive requests and respond accordingly.

Referring to FIG. 2, a block schematic diagram 200 is provided illustrating one or more artificial intelligence platform tools, as shown and described with respect to FIG. 1A-1D, and their associated application program interfaces, in accordance with some embodiments of the present disclosure. An application program interface (API) is understood in the art as a software intermediary, e.g., invocation protocol, between two or more applications which may run on one or more computing environments. As shown, a tool is embedded within the AI platform 250 (shown and described in FIGS. 1A, 1B, and 1C as the AI platform 150), one or more APIs may be utilized to support one or more of the tools therein, including the autonomous vehicles parking manager 251 (shown and described as the autonomous vehicles parking manager 151 with respect to FIGS. 1A and 1B) and its associated functionality. Accordingly, the AI platform 250 includes the tool including, but not limited to, the autonomous vehicles parking manager 251 associated with an API₀ 212.

The API₀ 212 may be implemented in one or more languages and interface specifications. API₀ 212 provides functional support for, without limitation, the autonomous vehicles parking manager 251 that is configured to facilitate execution of one or more operations by the server 110 (shown in FIG. 1A). Such operations include, without limitation, collecting, storing, and recalling the data stored within the data corpus 171 as discussed herein, and providing data management and transmission features not provided by any other managers or tools (not shown). Accordingly, the autonomous vehicles parking manager 251 is configured to facilitate building, storing, and managing the data in the data corpus 171 including, without limitation, joining of the data resident therein.

In at least some embodiments, the components, i.e., the additional support tools, embedded within the autonomous vehicles parking manager 151/251, including, without limitation, and referring to FIGS. 1A, 1B, and 1C, the augmented reality (AR) engine 252 (shown and described as the augmented reality (AR) engine 152 in FIG. 1B, including the embedded parking facility emulation module 153, parking facility object identification module 154, AR interface module 155, inter-vehicle communication module 156, real time data integration module 157, user retrieval module 158, and inclement weather avoidance module 159), the parking engine 256 (shown and described as the parking engine 160 in FIG. 1B, including the embedded parking recommendation module 161 and the parking selection and vehicle navigation module 162), and the modeling engine 258 (shown and described as the modeling engine 163 in FIG. 1B, including the user preferences module 165, and the functionality thereof (as described further herein with respect to FIGS. 3-5C)) are also implemented through an API. Specifically, the augmented reality (AR) engine 254 is associated with an API₁ 214, the parking engine 256 is associated with an API₂ 216, and the modeling engine 258 is associated with an API₃ 218. Accordingly, the APIs API₀ 212 through API₃ 218 provide functional support for the operation of the autonomous vehicles parking manager 151 through the respective embedded tools.

In some embodiments, as described for FIG. 1C, the AI platform 150 includes one or more supplemental managers M (only one shown) and one or more supplemental engines N (only one shown) that are employed for any supplemental functionality in addition to the functionality described herein. Accordingly, the one or more supplemental managers M are associated with one or more APIs_{M} 224 (only one shown) and the one or more supplemental engines N are associated with one or more APIs_{N} 226 (only one shown) to provide functional support for the operation of the one or more supplemental managers M through the respective embedded tools.

As shown, the APIs API₀ 212 though API_{N} 226 are operatively coupled to an API orchestrator 270, otherwise known as an orchestration layer, which is understood in the art to function as an abstraction layer to transparently thread together the separate APIs. In at least one embodiment, the functionality of the APIs API₀ 212 though API_{N} 226, and any additional APIs, may be joined or combined. As such, the configuration of the APIs API₀ 212 through API_{N} 226 shown herein should not be considered limiting. Accordingly, as shown herein, the functionality of the tools may be embodied or supported by their respective APIs API₀ 212 through API_{N} 226.

In at least some embodiments, and referring to FIGS. 1A through 1C, as well as FIG. 2, the tools embedded within the AI platform 150 as shown and described herein include, but are not limited to, the following functionalities. In addition, the AI platform 150 uses at least a portion of the data resident within the data corpus 171, and more specifically, the historical database 172.

As previously described, the augmented reality (AR) engine 152/254 includes the embedded parking facility emulation module 153, the parking facility object identification module 154, the AR interface module 155, the inter-vehicle communication module 156, the real time data integration module 157, the user retrieval module 158, and the inclement weather avoidance module 159. In general, the AR engine 152/254 facilitates, through the respective modules, functions that include, without limitation, enhancing operation of autonomous vehicles, and, more specifically, toward using augmented reality to enhance parking of autonomous vehicles. Such operational enhancements include, without limitation, facilitating collaboration between other autonomous vehicles and augmented reality to project a digital model of the respective parking facility with proximate surroundings and spaces that are available to park vehicles. The AR engine 152/254 further facilitates, through the respective modules, functions that include, without limitation, permitting a user to choose an appropriate parking spot within the AR interface to park their vehicle. In addition, the AR engine 152/254 further facilitates the users to specify an occupant pickup point and facilitate collaboration with the other autonomous vehicles and proximate surroundings to reduce any potential for damage as the vehicle leaves the parking spot and drives itself towards the occupant pickup spot. In some embodiments, the AR engine 152/254 uses the typical vehicle movement temporal data 173, known vehicular attributes data 174, known parking facility attributes data 175, parking facility rules, regulations, and procedures data 176, historical traffic/weather/roads conditions data 177, user preferences data 178, and historical parking facility AR emulation data 179. Each of the respective modules embedded in the AR engine 152/254 are discussed individually.

In some embodiments, the AR engine 152/254 includes features that facilitate the occupants using the AR features to directly opt-in/op-out for privacy purposes.

In at least some embodiments, the parking facility emulation module 153 facilitates executing an analysis of the various inputs from devices such as, and without limitation, sensors that include the IoT devices 180-7, e.g., cameras, that define the local surrounding IoT ecosystem of the vicinity of the respective parking facility. More specifically, the parking facility emulation module 153 receives the real time image data of the parking facility from the sensors and creates a digital model of the parking facility. The real time digital model of the parking facility is transmitted to the parking facility computing system 166. In addition, the parking facility emulation module 153 is configured to automatically establish communications with any autonomous vehicle that is determined to be approaching the parking facility in real time, where any visual information from the vehicles is potentially added to the real time digital image of the parking facility, and the digital image is transmitted to the vehicle. In some embodiments, the parking facility emulation module 153 uses the parking facility rules, regulations, and procedures data 176, and the historical parking facility AR emulation data 179.

In one or more embodiments, the parking facility object identification module 154 is configured to identify the real time position and the vehicular details of the incoming autonomous vehicles, including, without limitation, the make, model, year, physical dimensions, and the like. As such, the parking facility object identification module 154 is configured to determine the vehicles arriving, leaving, and moving within the parking facility through sensors that include, without limitation, IoT devices 180-7, e.g., cameras, RF transmitters on the vehicles, and transponders on the vehicles. In addition, through the parking facility object identification module 154 and the AR overlay for pickup way point and routing selection (as previously described), as the arriving autonomous vehicle approaches the parking facility, the approaching vehicle can identify the other vehicles in the surrounding IoT ecosystem, thereby facilitating the picking of the parking space(s). In some embodiments, the parking facility object identification module 154 uses the known vehicular attributes data 174 and the known parking facility attributes data 175.

In at least some embodiments, the AR interface module 155 facilitates the user's interface with the AR engine 152/254 to operate the respective autonomous vehicle, either locally within the vehicle or remotely through an interface. In addition, in some embodiments, the AR engine 152/254 provides an AR version of the parking facility (or facilities) on a real time basis such that the user can select the parking location. Further, in some embodiments, the AR interface module 155 facilitates identifying to the AR engine 152/254 that the respective autonomous vehicle is within a threshold range of the respective parking facility that, in some embodiments, is used to trigger initiation of the AR interface (i.e., a GUI as a nonlimiting example of the visual display 130) associated with the AR interface module 155. In some embodiments, the parking facility computing system 166 is notified of the approaching vehicle in cooperation with the parking facility emulation module 153. In addition, in some embodiments, in conjunction with the parking facility emulation module 153, the parking selection and vehicle navigation module 162, the AR overlay for obstacle identification and routing amelioration (as previously discussed), and the AR for overlay obstacle identification and routing amelioration (as previously discussed), the AR interface module 155, through the GUI, facilitates the user's navigation of the entire parking facility via the respective parking facility targeted AR overlay to select the desired parking location.

In one or more embodiments, the AR interface module 155 facilitates collecting from the parking facility computing system 166 (as a nonlimiting example) any requirements, rules, procedures, regulations, and notifications associated with the parking facility, where they are also provided to the user via the respective GUI through the ruleset for the targeted AR overlay for space availability, where such rules include, without limitation, prohibiting certain vehicles from entry, not permitting selection of other parking facilities, any operation of the vehicle that may interfere with other vehicles, and the like. Moreover, in some embodiments, the AR interface module 155, in cooperation with the parking selection module and vehicle navigation module 162, and the AR overlay for obstacle identification and routing amelioration (as previously discussed), facilitates the user proactively selecting the parking facility through one or more of finger gestures and eye gestures through the GUI. Also, in some embodiments, the AR interface module 155, in cooperation with the parking selection and vehicle navigation module 162, and the AR overlay for obstacle identification and routing amelioration (as previously discussed), facilitates users' interactions with the AR engine 152/254 through a GUI, either locally within the vehicle or remotely through a hand-held interface such as the mobile phone 180-1 and the tablet 180-3. Such interactions include, without limitation, the user selects any parking space, and accordingly, the same will be communicated to the parking facility computing system 166. Further, in some embodiments, the AR interface module 155 communicates to the parking facility computing system 166 that the selected parking space is no longer available and will update the targeted AR overlay of the parking facility accordingly. In some embodiments, the AR interface module 155 is used to call the parked vehicle, where the parked autonomous vehicle can autonomously, or under user navigation, transit to the designated location, in cooperation with the user retrieval module 158 and the AR overlay for pickup way point and routing selection (as previously described). In some embodiments, the AR interface module 155 is configured to notify the user when and where the vehicle will pick up the occupants. Further, in some embodiments, the user can command the AR interface module 155, in cooperation with the user retrieval module 158 and the AR overlay for pickup way point and routing selection (as previously described), to use the targeted AR overlay of the parking facility and associated surroundings to track the movement of the user to determine when the autonomous vehicle is to start transiting from the parking facility.

In at least some embodiments, the inter-vehicle communication module 156, in cooperation with the parking selection and vehicle navigation module 162, and the AR overlay for obstacle identification and routing amelioration (as previously discussed), facilitates the communications between the proximate autonomous vehicles in the vicinity of the parking facility, including the arriving autonomous vehicles, parked vehicles, and transiting vehicles (including departing vehicles), such that the vehicles operate in a collaborative manner to manage the dynamic vehicle population. Also, in some embodiments, the inter-vehicle communication module 156, in cooperation with the user retrieval module 158 and the AR overlay for pickup way point and routing selection (as previously described), facilitates the incoming autonomous vehicle identifying the other vehicles in the surrounding vicinity, whether stationary or transiting, to facilitate arriving at the designated parking location without incident. Such communications are facilitated through sensors that include one or more of the IoT devices 180-7, RF transmitters, RF receivers, transponders, etc. In some embodiments, the inter-vehicle communication module 156 uses the known vehicular attributes data 174.

In one or more embodiments, the real time data integration module 157 facilitates the AR engine 152 collecting the real time digital model of the parking facility from the parking facility computing system 166 as the vehicle approaches the designated parking facility. In addition, in some embodiments, the real time data integration module 157 facilitates updating the AR parking facility overlay on a real time basis to the parking facility computing system 166 as the vehicle transits through the designated parking facility.

In at least some embodiments, the user retrieval module 158, in cooperation with the AR interface module 155, facilitates calling the parked vehicle, where the parked autonomous vehicle can autonomously, or under user navigation, transit to the designated location, in cooperation with the user retrieval module 158 and the AR overlay for pickup way point and routing selection (as previously described). Therefore, in some embodiments, the AR interface module 155 is configured to notify the user when and where the vehicle will pick up the occupants. In at least some embodiments, the user retrieval module 158, in cooperation with the AR interface module 155 and the AR overlay for pickup way point and routing selection (as previously described), to use the targeted AR overlay of the parking facility and associated surroundings to track the movement of the user to determine when the autonomous vehicle is to start transiting from the parking facility. Also, in some embodiments, the user retrieval module 158, in cooperation with the inter-vehicle communication module 156 and the AR overlay for pickup way point and routing selection (as previously described), facilitates the incoming autonomous vehicle identifying the other vehicles in the surrounding vicinity, whether stationary or transiting, to facilitate arriving at the designated parking location without incident. In some embodiments, the user retrieval module 158 uses the typical vehicle movement temporal data 173, the known vehicular attributes data 174, the known parking facility attributes data 175, and the parking facility rules, regulations, and procedures data 176.

In one or more embodiments, the inclement weather avoidance module 159 facilitates successful navigation through environmental conditions such as weather (gloomy, cloudy, rainy, hot and humid, etc.) and the real time traffic and road conditions are incorporated into the implementation of the embodiments described herein. In some embodiments, the historical traffic/weather/road conditions data 177 are also used if necessary as a function of the location of the offboarding and onboarding of occupants, as well as the parking activities, including through previous modeling activities through the modeling engine 163. The historical traffic/weather/road conditions data 177 includes, without limitation, those traffic, weather, and road conditions conducive to executing the operations of the AR engine 152. In addition, the historical traffic/weather/road conditions data 177 includes, without limitation, those weather conditions unfavorable to executing the operations of the AR engine 152. For example, and without limitation, inclement weather will necessarily induce the trained models in the artificial intelligence platform 150 to alter, as necessary, the parking actions of the respective autonomous vehicles to meet at least a portion of the intentions of the autonomous vehicles parking manager 151/252.

It is noted that in many cases the parking facility may be covered, thereby minimizing the impact of inclement weather conditions beyond the entrance to the parking facility; however, in contrast, some parking facilities are not completely enclosed and are thereby subject to snow drifts, horizontal rain, high winds, high/low temperatures, and the like. In at least some embodiments, the models of the autonomous vehicles parking manager 151/252 are trained to mitigate the impact of substantially all inclement weather conditions associated with a myriad of parking facilities and scenarios. Accordingly, in at least some embodiments, the historical traffic/weather/road conditions data 177 is used to train the models in the engine 163, through the models learning modules 164 embedded in the modeling engine 163. Such historical traffic/weather/road conditions data 177 is used to leverage previous actions executed as a function of weather conditions in collaboration with the real time weather conditions as captured through the information handling devices 180. In some embodiments, the systems, computer program products, and methods described herein implement an AR overlay as previously described for weather inclusion and avoidance for the current weather conditions based on the current and forecasted weather data from a one or more of the information handling devices 180, or, in some cases, a referenced weather API.

In at least some embodiments, the parking engine 160/256, including the embedded parking recommendation module 161 and the parking selection and vehicle navigation module 162, facilitates the autonomous vehicle parking manager 151 in executing the generation of providing recommendations for parking locations (including parking facilities and spaces) and facilitating the selection of the parking location and navigating the vehicle to the selected location. The parking engine 160/256 uses AR features to project a digital model of the various parking facilities with surroundings and spaces that are available to park the respective vehicle(s). Accordingly, the parking engine 160/256 uses the AR overlay with weighting and conflict priority management as previously described. The parking recommendation module 161 is configured to permit a user to choose an appropriate parking spot within the AR interface to park their vehicle. In addition, the parking engine 160/256, based on historical selection of types of parking spots, rules for parking, e.g., handicap parking spots, reserved spots, parking spots with a time limit, etc. (as a function of the ruleset for the targeted AR overlay for space availability), based on the user's contextual situation, and the other properties of the parking facility, identify available parking spaces for the vehicle. The system learns user's preferences and recommends spots based on the preference, e.g., near an elevator. The recommended parking space is shown on the augmented reality interface of the entire parking facility and accordingly the user can select the required parking space for the vehicle. These functionalities are discussed in further detail with respect to the two modules embedded within the parking engine 160/256.

In some embodiments, the parking recommendation module 161 facilitates the historical learning of the details of the parking facilities and the parking locations therein, the parameters of the vehicle and the parking spaces, as well as the respective users' preferences, to generate the recommendations to the user, using the AR overlay for pickup way point and routing selection (as previously described). In addition, the parking recommendation module 161 facilitates generating recommendations for another nearby parking facility that could be made to the user prior to attempting to parking the vehicle if the facility is full or it is anticipated there will not be a spot by the time of arrival. In some embodiments, the parking recommendation module 161 uses the known vehicular attributes data 174, the parking facility rules, regulations, and procedures data 176, and the user preferences data 178.

In one or more embodiments, for the parking selection features, the parking selection and vehicle navigation module 162 provides an AR version of the parking facility (or facilities) on a real time basis such that the user can select the parking location. In one or more embodiments, the parking selection and vehicle navigation module 162, in cooperation with the AR interface module 155, facilitates collecting from the parking facility computing system 166 (as a nonlimiting example) any requirements, rules, procedures, regulations, and notifications associated with the parking facility, where they are also provided to the user via the respective GUI, where such rules include, without limitation, prohibiting certain vehicles from entry, not permitting selection of other parking facilities, any operation of the vehicle that may interfere with other vehicles, and the like. Moreover, in some embodiments, the parking selection and vehicle navigation module 162, in cooperation with the AR interface module 155, facilitates the user proactively selecting the parking facility through one or more of finger gestures and eye gestures through the GUI.

In addition, for the parking selection features, in some embodiments, the parking selection and vehicle navigation module 162 facilitates, at least partially based on the selection of the parking space on the AR interface module 155, the user can select the parking facility and reserve the parking space, and accordingly the vehicle will be identifying the parking facility where the vehicle needs to park. In some embodiment, the parking selection and vehicle navigation module 162, in cooperation with the AR interface module 155, facilitates communicating to the parking facility computing system 166 the user selected parking space and that the selected parking space is no longer available and will update the targeted AR overlay of the parking facility accordingly.

In some embodiments, for the vehicle navigation features, the parking selection and vehicle navigation module 162, in cooperation with the parking facility emulation module 153, the AR interface module 155, and the AR overlay for obstacle identification and routing amelioration (as previously discussed), facilitates, through the GUI, the user's navigation of the entire parking facility via the respective parking facility targeted AR overlay to select the desired parking location. Moreover, in some embodiments, the parking selection module and vehicle navigation module 162, in cooperation with the AR interface module 155, facilitates the user proactively navigating the parking facility through one or more of finger gestures and eye gestures through the GUI. Also, in some embodiments, the parking selection and vehicle navigation module 162, in cooperation with the AR interface module 155, and the AR overlay for obstacle identification and routing amelioration (as previously discussed), facilitates users' interactions with the AR engine 152/254 through a GUI, either locally within the vehicle or remotely through a hand-held interface such as the mobile phone 180-1 and the tablet 180-3. In at least some embodiments, the parking selection and vehicle navigation module 162, in cooperation with the inter-vehicle communication module 156, and the AR overlay for obstacle identification and routing amelioration (as previously discussed), facilitates the communications between the proximate autonomous vehicles in the vicinity of the parking facility, including the arriving autonomous vehicles, parked vehicles, and transiting vehicles (including departing vehicles), such that the vehicles operate in a collaborative manner to manage the dynamic vehicle population. In some embodiments, the parking selection and vehicle navigation module 162 uses the typical vehicle movement temporal data 173, the parking facility rules, regulations, and procedures data 176, and the user preferences data 178.

In at least some embodiments, the modeling engine 258 (shown and described as the modeling engine 163 in FIG. 1B, including the user preferences module 165), and the functionality thereof facilitates the historical learning of the details of the parking facilities and the parking locations therein, the parameters of the vehicle and the parking spaces, as well as the respective users' preferences, to generate the recommendations to the user, using the AR overlay for pickup way point and routing selection (as previously described). In some embodiments, the modeling engine 163/258 uses the data in the historical database 172, including the user preferences data 178, as well as any data available through the computer network 105 that enables operation of the system 100 as described herein. In addition, the modeling engine 163/258 is configured to create and modify the various AR overlays as described herein, including, without limitation, the targeted AR overlays of the entire parking facility and the pickup way point and routing selection using the rulesets for the targeted AR overlay for space availability, the weighting and conflict priority management, obstacle identification and routing amelioration, weather inclusion and avoidance, as well as the multiple vehicle AR overlay for call requests.

The one or more models learning modules 164 are configured to train the models that are resident in the modeling engine 163/258. In order to facilitate the training of the models, the models learning modules 164 ingest data from the data corpus, including the historical database 172, and real time data collected through the computer network 105. For example, and without limitation, the models learning modules 164 create models of the selected parking facilities and the proximate environment, including historical and real time vehicular and pedestrian traffic conditions, to predict and identify patterns therein. In addition, the particular vehicles used by the operators and containing the other occupants (passengers) are modeled by the models learning modules 164 to facilitate an accurate and precise integration of those vehicles into the AR environment. Moreover, the historical traffic, weather, and road conditions are used to leverage previous actions executed as a function of such conditions in collaboration with the real time conditions as captured through the information handling devices 180. Furthermore, the modeling engine 163, including the models learning modules 165 and the embedded models resident therein, facilitates initial and continuous training of the models with the data resident within at least a portion of the historical database 172 as well as the data received through the computer network 105.

Referring to FIG. 3, a schematic diagram is presented illustrating portions of the system 100 as shown and described with respect to FIGS. 1A-1D and 2 in a simplified configuration 300, in accordance with some embodiments of the present disclosure. The numbering from FIGS. 1A-1D and 2 is used where appropriate. The configuration 300 includes one or more autonomous vehicles 302. In some embodiments, the autonomous vehicle 302 is any vehicle configured to employ the system 100 in the configuration 300 as described herein, including, without limitation, a car, bus, truck, or a van. The configuration 300 also includes the autonomous vehicles parking system 151/251 coupled communicatively and operably with the vehicle 302, as well as the parking facility computing system 166.

An operator (or other occupant) 304 of the vehicle 302 is shown in FIG. 3. In some embodiments the vehicle 302 includes an AR interface 306 that facilitates local interfacing with the autonomous vehicles parking manager 151/251 (for example, through the AR interface module 155) by the operator 304 of the vehicle 302. In some embodiments, the local interface of the operator 304 is enhanced through the AR glasses/goggles 180-8. Also, in some embodiments, remote operable communication with the autonomous vehicles parking system 151/251 is implemented through, without limitation, one or more of the mobile phone 180-1, the tablet 180-3, and the AR glasses/goggles 180-8.

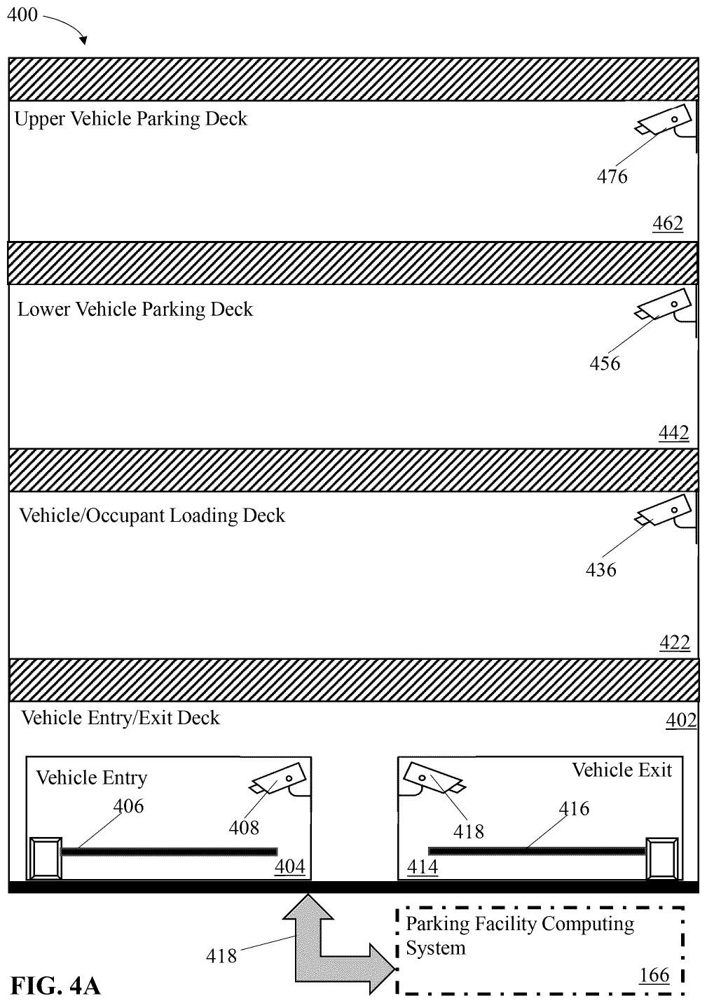

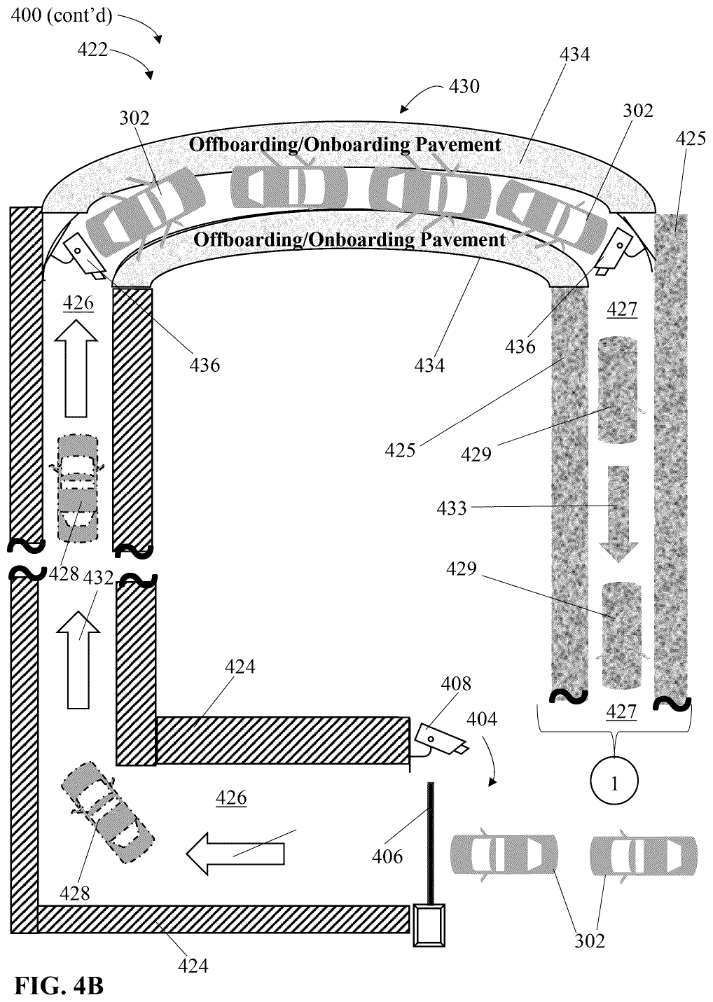

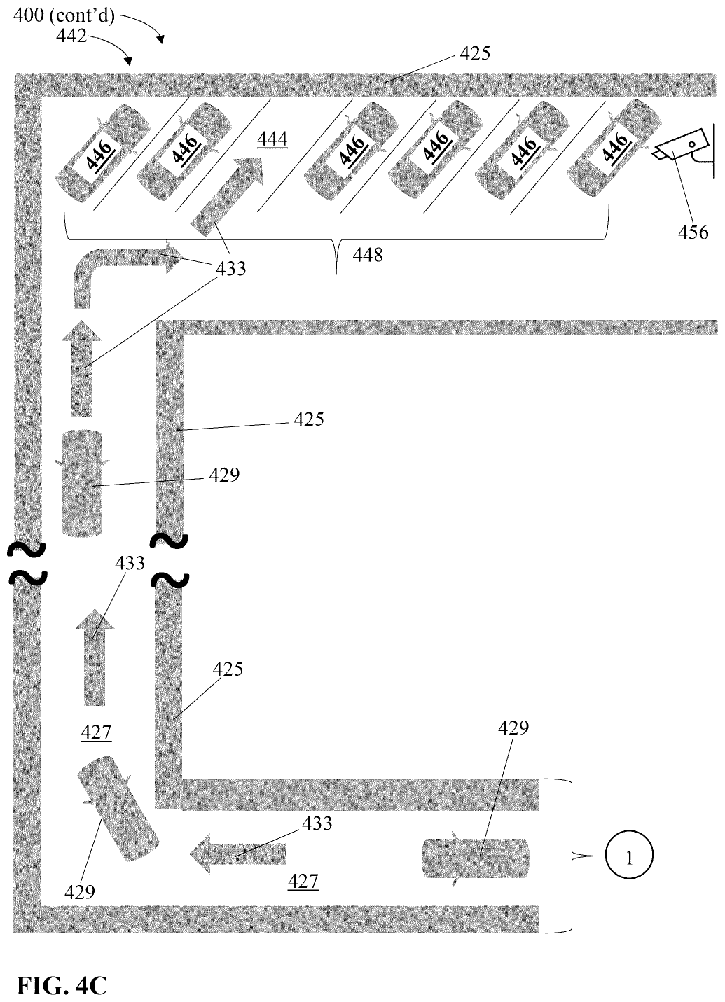

Referring to FIG. 4A, a schematic cutaway diagram is presented illustrating a portion of a parking facility 400, in accordance with some embodiments of the present disclosure. In at least some embodiments, the parking facility 400 includes a vehicle entry and exit deck 402 that includes a vehicle entry portal 404 and a vehicle exit portal 414. The vehicle entry portal 404 includes a gate mechanism 406 and at least one entrance camera 408. Similarly, in at least some embodiments, the vehicle exit portal 414 includes a gate mechanism 416 and at least one exit camera 418. The parking facility 400 includes the parking facility computing system 166 (see FIG. 1C) that is communicatively and operably coupled to the physical structures of the parking facility 400 as shown through arrow 418. In some embodiments, the parking facility object identification module 154 (see FIG. 1B) is used for identifying that the respective vehicle 302 (see FIG. 3) is one of fully-autonomous, semi-autonomous, or non-autonomous and is approaching the vehicle entry portal 404 of the parking facility 400 as the vehicle 302 is discovered by sensing devices such as the entrance camera 408 or other IoT devices 180-7 (see FIG. 1A) (including vehicle-mounted cameras) and AR-based vision enhancements such as the AT goggles/glasses 180-8 (see FIG. 1A). Similar features are used at the vehicle exit 412.

In one or more embodiments, the parking facility 400 includes a vehicle/occupant loading deck 422 that includes one or more loading deck cameras 436. The vehicle/occupant loading deck 422 is discussed further with respect to FIG. 4B. The parking facility 400 also includes a lower vehicle parking deck 442 and an upper vehicle parking deck 462 that include one or more parking deck cameras 456 and 476, respectively. The lower and upper vehicle parking decks 442 and 462, respectively, are discussed further with respect to FIG. 4C. In some embodiments, the physical layout of the parking facility 400 is any configuration that enables operation of the system 100, including the artificial intelligence platform 150 and the embedded autonomous vehicles parking manager 151/251 as described herein.

Referring to FIG. 4B, a schematic overhead diagram is presented illustrating a portion of the parking facility 400 presented in FIG. 4A, in accordance with some embodiments of the present disclosure. Specifically, the vehicle/occupant loading deck 422 is shown and described as follows. In some embodiments, the parking facility 400, including the vehicle/occupant loading deck 422 is emulated through the parking facility emulation module 153. In addition, in some embodiments, the artificial intelligence platform 150 uses the AR engine 152 of the autonomous vehicles parking manager 151/251, and more specifically, one or more of the parking facility emulation module 153, the parking facility object identification module 154, the AR interface module 155, the inter-vehicle communication module 156, and the real time data integration module 157 (see FIG. 1B) to determine if the incoming vehicle 302 is assigned to general parking or assigned parking. Those vehicles 302 that are assigned a specific parking space are directed to that space using at least a portion of the features described herein. In addition, those vehicles 302 assigned to general parking also use at least a portion of the features described herein.

In at least some embodiments, in addition to the vehicle entry portal 404, the gate mechanism 406, and at least one entrance camera 408, the parking facility 400 also includes one or more walls 424 that define a path 426 to guide a transiting vehicle 428 (shown in phantom in FIG. 4B) to a vehicle/passenger loading area 430 that is configured to facilitate offboarding and onboarding of the passengers of the respective vehicles. The transiting vehicle 428 is initially guided through devices such as painted arrows 432 and the walls 424 toward an occupant offboarding/onboarding pavement 434. In some embodiments, there is one occupant offboarding/onboarding pavement 434 on one side of the vehicles 302, while in the illustrated embodiment, two occupant offboarding/onboarding pavements 434 on each side of the vehicles 302 are present. In addition, in some embodiments, the vehicle/passenger loading area 430 includes more than one path 426, i.e., vehicular approach lanes 426 that are configured to accommodate a string of vehicles 302. In some embodiments, the vehicle/passenger loading area 430 on the vehicle/occupant loading deck 422 includes additional IoT devices, for example, IoT devices 180-7 and additional mounted cameras 436, as well as any vehicle-mounted cameras (not shown to observe and record the traffic to and from the vehicle/passenger loading area 430. Such recorded data is stored in the typical vehicle movement temporal data 173.

In some embodiments, the vehicle/passenger loading area 430 is not positioned within the parking facility 400. Rather, in some embodiments, the vehicle will be emptied of all occupants, including the operator, prior to the transiting vehicle 428 entering the parking facility 400. In some embodiments, the vehicle will be emptied of all passengers and the operator will drive the transiting vehicle 428 to the parking facility 400. These two embodiments are discussed further with respect to FIG. 4C.

In some embodiments, within the parking facility 400, the operator of the transiting vehicle 428 will allow the passengers to offboard at the vehicle/passenger loading area 430, while the operator will drive the transiting vehicle 428 to the parking space. In some embodiments, the driver will also offboard the transiting vehicle 428 at the vehicle/passenger loading area 430 and the transiting vehicle 428 will be navigated to the parking location autonomously, or semi-autonomously in cooperation with the operator, where both embodiments are implemented through the autonomous vehicles parking manager 151/251, and are discussed further as follows and elaborated with respect to FIG. 4C.

For those embodiments where the transiting vehicle 428 is navigated to the parking location autonomously, or semi-autonomously in cooperation with the operator, the AR engine 152/252 is engaged. In some embodiments, the AR engine 152/252 provides the additional vehicular AR-based guidance in the form of an overhead view display of the respective transiting vehicle 428 in the AR interface 306 (see FIG. 3) within the transiting vehicle 428 as shown in FIG. 4B as a virtual vehicle 429. The AR engine 152/252 also generates virtual objects that are similar to their real world counterparts, for example, as shown, the walls 424 are displayed as virtual walls 425. In addition, a virtual arrow 433 is presented to the operator of the transiting vehicle 428/429 within a virtual path 427 (an AR replica of path 426) to drive toward the designated parking space.

Also, in at least some embodiments, one or more multiple vehicle AR overlays may be used for selecting multiple parking facilities for multiple vehicles (e.g., travelling in a group), selecting multiple parking locations in a single parking facility (e.g., parking facility 400), or calling multiple vehicles from the one or more parking facilities to the pickup location, i.e., the vehicle/passenger loading area 430.

Referring to FIG. 4C, a schematic overhead diagram is presented illustrating a portion of the parking facility presented in FIGS. 4A and 4B, in accordance with some embodiments of the present disclosure. Specifically, the lower vehicle parking deck 442 is shown and described as follows. In some embodiments, the upper level parking deck 462 is substantially similar to the lower vehicle parking deck 442. In some embodiments, the parking facility 400 is emulated through the parking facility emulation module 153. In addition, in some embodiments, the artificial intelligence platform 150 uses the AR engine 152 of the autonomous vehicles parking manager 151/251, and more specifically, one or more of the parking facility emulation module 153, the parking facility object identification module 154, the AR interface module 155, the inter-vehicle communication module 156, and the real time data integration module 157 (see FIG. 1B) to determine if the transiting vehicle 428/429 is assigned to general parking or assigned parking. Those vehicles 428/429 that are assigned a specific parking space are directed to that space using at least a portion of the features described herein. In addition, those vehicles 428/429 assigned to general parking also use at least a portion of the features described herein.

In one or more embodiments, the inter-vehicle communication module 156 and real time data integration module 157 facilitate one or more functions that include, without limitation, each autonomous vehicle 302 collaborating with each other and the transiting vehicle 428/429 via the surrounding IoT ecosystem through, for example, and without limitation, the IoT devices 180-7 and the AR-based vision enhancements such as the AT goggles/glasses 180-8, to identify the appropriate available space 444. Such IoT devices 180-7 may include additional parking facility cameras 456 and vehicle-mounted cameras. In addition, in some embodiments, the locations of the other vehicles 446 (shown virtually in FIG. 4C) within the lower parking deck 442, regardless of the level of autonomy, may be discovered through visual means of the operator of the vehicle 428/429. Accordingly, such collaboration facilitates determining a location to park the transiting vehicle 428/429, including an angle, direction, and physical position of the vehicle 428/429 at least partially based on the calculated locations of the other AR vehicles 446 within the vicinity of the parking area 448.

Referring to FIGS. 4B and 4C, in one or more embodiments the operator of the vehicle 428/429 will exit the vehicle 428/429 at the vehicle/passenger loading area 430, and the vehicle 428/429 transits from the vehicle/passenger loading area 430 to the parking location 444 fully autonomously using the parking selection and vehicle navigation module 162 in cooperation with the parking facility emulation module 153, the AR interface module 155, and the AR overlay for obstacle identification and routing amelioration (as previously discussed herein). In some embodiments, the vehicle 428/429 transits from the vehicle/passenger loading area 430 to the parking location 444 semi-autonomously, i.e., the operator locally interfaces with the vehicle 428/429 through one or more of the AR interface module 155, the AR interface 306, and the AR glasses/goggles 180-8. In some embodiments, the operator will remotely navigate the vehicle 428/429 through the parking facility 400 through devices such as, and without limitation, one or more of the mobile phone 180-1, the tablet 180-3, and the AR glasses/goggles 180-8, through the AR interface module 155. Transiting the vehicle 428/429 through these three modes is substantially similar if the vehicle/passenger loading area is remote to the parking facility 400, where the AR interface engine 152/252, the parking engine 160/256, and the modeling engine 163/258 are additionally configured to facilitate the transit of the vehicle 428/429 from the remote passenger loading/unloading location to the parking location 444, including, without limitation, through the associated traffic thoroughfares.

Continuing to refer to FIGS. 4B and 4C, in one or more embodiments, the users can call to have the vehicle 428/429 pick them up at the designated spot, e.g., the vehicle/passenger loading area 430. The vehicle 428/429 presently in parking location 444 receives the call from the user(s) at the vehicle/passenger loading area 430. In some embodiments, the operator of the vehicle 428/429 will remotely call the vehicle 428/429 from the vehicle/passenger loading area 430, and the vehicle 428/429 transits from parking location 444 to the vehicle/passenger loading area 430 fully autonomously using the parking selection and vehicle navigation module 162 in cooperation with the parking facility emulation module 153, the AR interface module 155, the for obstacle identification and routing amelioration, and the user retrieval module 158 (as previously discussed herein). In some embodiments, the vehicle 428/429 transits from the parking location 444 to the vehicle/passenger loading area 430 semi-autonomously, i.e., the operator locally interfaces with the vehicle 428/429 through one or more of the user retrieval module 158, the AR interface module 155, the AR interface 306, and the AR glasses/goggles 180-8. In some embodiments, the operator will remotely navigate the vehicle 428/429 through the parking facility 400 through devices such as, and without limitation, one or more of the mobile phone 180-1, the tablet 180-3, and the AR glasses/goggles 180-8, through the AR interface module 155 and the user retrieval module 158. Transiting the vehicle 428/429 through these three modes is substantially similar if the vehicle/passenger loading area is remote to the parking facility 400, where the AR interface engine 152/252, the parking engine 160/256, and the modeling engine 163/258 are additionally configured to facilitate the transit of the vehicle 428/429 from parking location 444 to the remote passenger loading/unloading location, including, without limitation, through the associated traffic thoroughfares.

Also, in at least some embodiments, one or more multiple vehicle AR overlays may be used for multiple parking facilities for multiple vehicles (e.g., travelling in a group), selecting multiple parking locations in a single parking facility (e.g., parking facility 400), or calling multiple vehicles from the one or more parking facilities to the pickup location, i.e., the vehicle/passenger loading area 430.

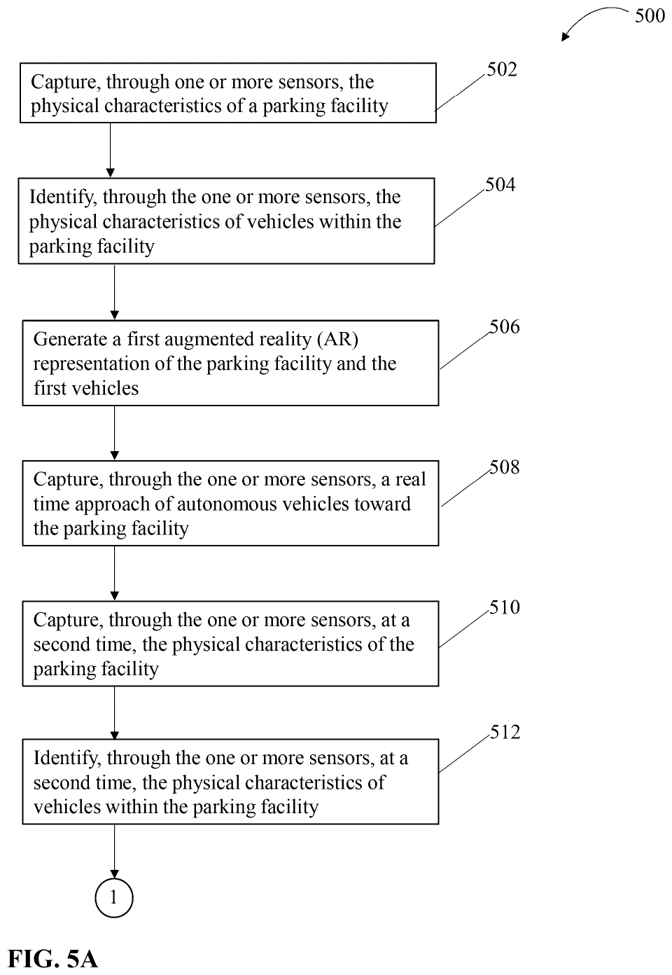

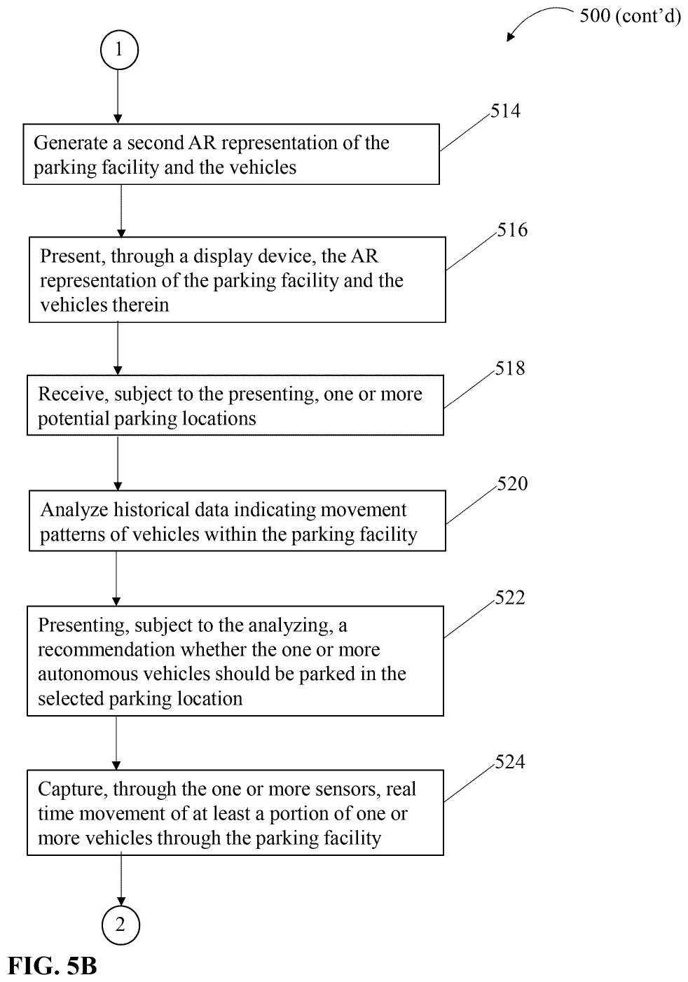

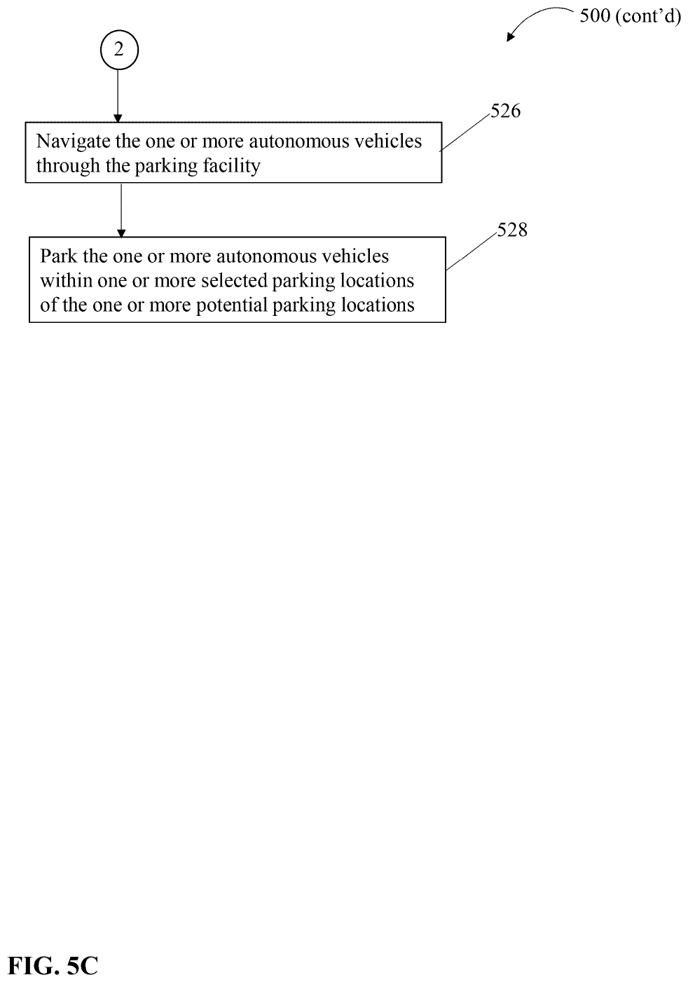

Referring to FIG. 5A, a flowchart is presented illustrating a process 500 for using augmented reality to enhance parking of autonomous vehicles, in accordance with some embodiments of the present disclosure. Also referring to FIGS. 1A-1D, 2, 3, and 4A-4C, the process 500 includes capturing 502, through one or more sensors, and the parking facility emulation module 153, at least a portion of the physical characteristics of the parking facility 400. The sensors generate various inputs from devices such as, and without limitation, devices that include the IoT devices 180-7, e.g., cameras 408, 418, 436, 456, and 476, that define the local surrounding IoT ecosystem of the vicinity of the respective parking facility 400. The process 500 also includes identifying 504, through the one or more sensors, and the parking facility object identification module 154, at least a portion of the physical characteristics of at least a portion of first vehicles 302 within the parking facility 400. In some embodiments, the steps 502 and 504 are executed at a first time, i.e., an initial parking facility physical features data collection is executed with the vehicles 302 that are therein at that particular point in time are captured and stored in the known parking facility attributes data 175 and the known vehicular attributes data 174, respectively.

In one or more embodiments, the process 500 includes generating 506, subject to the capturing and identifying, an augmented reality (AR) representation of the at least a portion of the parking facility 400 and the at least a portion of the first vehicles 302 through the parking facility emulation module 153 and storing the result in the historical parking facility AR emulation data 179. In some embodiments, the step 506 is executed at a first time, i.e., a first AR representation is generated from the initial parking facility physical features data collection with the vehicles that are therein at that particular point in time. Accordingly, with the first AR representation, the system 100 identifies the features of the parking facility 400 that are pertinent to navigating a vehicle 302 therein, including without limitation, the parking locations 448 throughout, the vehicles 446 presently parked therein and the surrounding area. Vehicles that are moving are captured as well. The data associated with the moving vehicles 302 is stored in the typical vehicle movement temporal data 173.

In at least some embodiments, the process 500 includes capturing 508, through the one or more sensors, and the parking facility object identification module 154, a real time approach of the one or more autonomous vehicles, i.e., vehicle 428 toward the parking facility 400 through the parking facility object identification module 154. The step 508 includes determining if the vehicle is fully autonomous, semi-autonomous, or non-autonomous through the parking facility object identification module 154. In some embodiments, the process 500 includes re-executing the steps 502 and 504 to capture 510, through the one or more sensors, at a second time, at least a portion of the physical characteristics of the parking facility 400, identify, 512 through the one or more sensors, at the second time, at least a portion of the physical characteristics of at least a portion of the first vehicles within the at least a portion of the parking facility 400.

Referring to FIG. 5B, a continuation of the flowchart presented in FIG. 5A is presented, in accordance with some embodiments of the present disclosure. The process 500 further includes repeating the step 506 through generating 514, subject to the capturing 510 and identifying 512, at the second time, a second AR representation of the at least a portion of the parking facility 400 and the at least a portion of the first vehicles 302 therein. In some embodiments, the steps 510→512→514 are repeated at a predetermined periodicity, e.g., and without limitation, every 5 minutes. In some embodiments, rather than executing steps 510→512→514, the AR representation of the parking facility is updated continuously. In some embodiments, the steps 510→512→514 are executed on a periodic basis, e.g., and without limitation, daily to facilitate conduct of an audit with the most recent AR representation resulting from the continuous updates.

In at least some embodiments, the process 500 further includes presenting 516, through the AR interface module 155 and the visual display device 130, or one or more of the mobile phone 180-1, the tablet 180-3, the AT goggles/glasses 180-8, and the AR interface 306, the AR representation of the parking facility 400 and the first vehicles, i.e., the vehicles presently therein. The process 500 also includes receiving 518, subject to the presenting 516, through the parking recommendations module 161, one or more potential parking locations 448 at least partially based on presently vacant parking locations indicated within the AR representation of the parking facility 400 and the first vehicles therein. In some embodiments, the recommended parking location is recommended to the user based on the user preferences data 178 learned and stored through the modeling engine 163/258. In some embodiments, the user executes the decision process for the parking location selection, such decisions recorded within the user preferences data 178

In at least some embodiments, the process 500 further includes analyzing 520, through the modeling engine 163/258, historical data (from the typical vehicle movement temporal data 173) indicating movement patterns of the second vehicles within the parking facility 400, where the second vehicles are distinguished from the first vehicles. Specifically, the first vehicles include all of the vehicles in the parking facility at the time the data is captured, that are mostly stationary, and the second vehicles are exclusively those vehicles that are moving through the parking facility 400. The process 500 also includes presenting 522, subject to the analyzing 518, through the parking recommendations module 161, a recommendation whether the one or more autonomous vehicles should be parked in the selected parking location 444.

In some embodiments, the process 500 includes capturing 524, through the one or more sensors, and the parking facility object identification module 154, real time movement of at least a portion of one or more third vehicles through the parking facility, where the third vehicles are those vehicles presently moving in real time through the parking facility 400.

Referring to FIG. 5C, a continuation of the flowchart presented in FIGS. 5A and 5B is presented, in accordance with some embodiments of the present disclosure. The process 500 further includes navigating 526, at least partially through the AR representation of the parking facility 400 and the first, second, and third vehicles, the one or more autonomous vehicles through the parking facility 400, through the parking selection and vehicle navigation module 162. Such navigation 526 is executed one of autonomously, semi-autonomously, and non-autonomously. The process 500 also includes parking 528, through the parking selection and vehicle navigation module 162, the one or more autonomous vehicles within the one or more selected parking locations 444 of the one or more potential parking locations 448. After the location is selected, the AR representation of the parking facility 400 is updated and the parking location 444 is blocked by the real time data integration module 157. The parking facility 400 can be exited through the call mechanisms as previously described herein, where many of the steps described for the process 500 are repeated.

The embodiments as disclosed and described herein are configured to provide an improvement to human transport technology. Materials, operable structures, and techniques as disclosed herein can provide substantial beneficial technical effects. Some embodiments may not have all of these potential advantages and these potential advantages are not necessarily required of all embodiments. By way of example only, and without limitation, one or more embodiments may provide enhancements of using AR features to enhance parking autonomous vehicles, thereby integrating AR technology and autonomous vehicle technology into a practical application that improves the transport of humans.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

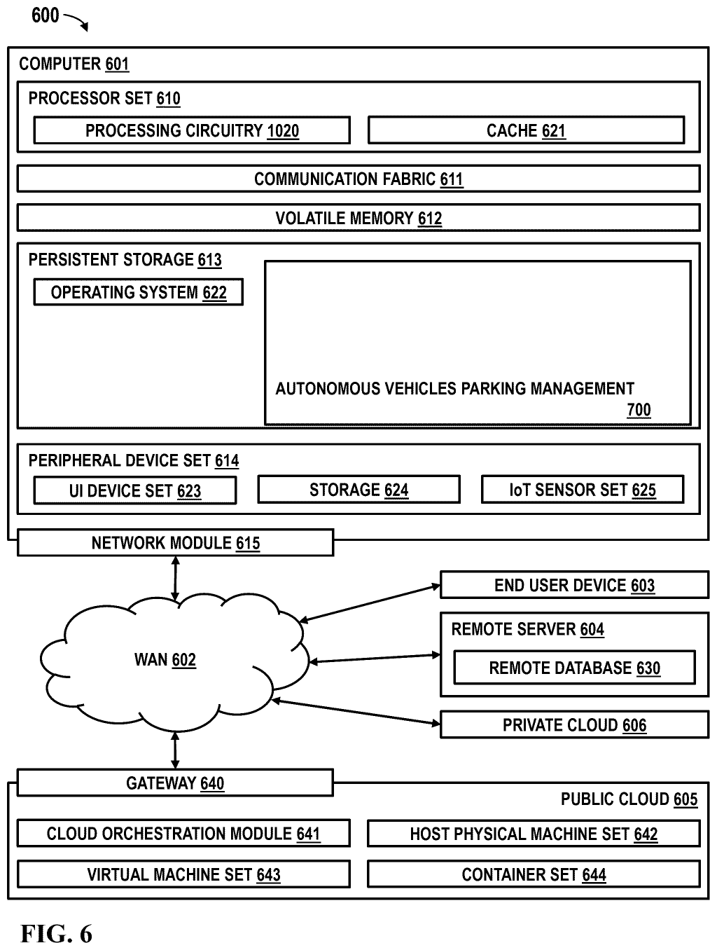

Referring to FIG. 6, a block schematic diagram is presented illustrating an example of a computing environment for the execution of at least some of the computer code involved in performing the disclosed methods described herein, in accordance with some embodiments of the present disclosure.

Computing environment 600 contains an example of an environment for the execution of at least some of the computer code involved in performing the disclosed methods, such as managing autonomous vehicles parking 700. In addition to block 700, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and block 700, as identified above), peripheral device set 614 (including user interface (UI) device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

Computer 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

Processor set 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the disclosed methods”). These computer readable program instructions are stored in various types of computer readable storage media, such as cache 621 and the other storage media discussed below. The program instructions, and associated data, are accessed by processor set 610 to control and direct performance of the disclosed methods. In computing environment 600, at least some of the instructions for performing the disclosed methods may be stored in block 700 in persistent storage 613.

Communication fabric 611 is the signal conduction path that allows the various components of computer 601 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 612 is any type of volatile memory now known or to be developed in the future. Examples include dynamic type random access memory (RAM) or static type RAM. Typically, volatile memory 612 is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

Persistent storage 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid state storage devices. Operating system 622 may take several forms, such as various known proprietary operating systems or open source Portable Operating System Interface-type operating systems that employ a kernel. The code included in block 700 typically includes at least some of the computer code involved in performing the disclosed methods.

Peripheral device set 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

Network module 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer readable program instructions for performing the disclosed methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN 602 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

Remote server 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

Public cloud 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer system for using augmented reality (AR) to enhance parking of autonomous vehicles comprising:
one or more processing devices;
one or more memory devices communicatively and operably coupled to the one or more processing devices; and
an autonomous vehicles parking manager communicatively and operably coupled to the one or more processing devices;
one or more sensors communicatively and operably coupled to the autonomous vehicles parking manager;
a display device communicatively and operably coupled to the autonomous vehicles parking manager;
one or more augmented reality (AR) devices communicatively and operably coupled to the autonomous vehicles parking manager, the autonomous vehicles parking manager configured to:
capture, through the one or more sensors, at least a portion of the physical characteristics of a parking facility;
identify, through the one or more sensors, at least a portion of the physical characteristics of at least a portion of first vehicles within the at least a portion of the parking facility;
generate, subject to the capturing and identifying, an AR representation of the at least a portion of the parking facility and the at least a portion of the first vehicles;
present, through the display device, the AR representation of the at least a portion of the parking facility and the at least a portion of the first vehicles;
receive, subject to the presenting, one or more potential parking locations at least partially based on presently vacant parking locations indicated within the AR representation of the at least a portion of the parking facility and the at least a portion of the first vehicles; and
park, subject to the receiving, one or more autonomous vehicles within one or more selected parking locations of the one or more potential parking locations.

2. The system of claim 1, wherein the autonomous vehicles parking manager is further configured to:
capture of the at least a portion of the physical characteristics of the parking facility, and identifying the at least a portion of the physical characteristics of the at least a portion of first vehicles within the at least a portion of the parking facility, at a first time; and
generate a first AR representation, at the first time, of the at least a portion of the parking facility and the at least a portion of the first vehicles:
capture, through the one or more sensors, at a second time, at least a portion of the physical characteristics of the parking facility;
identify, through the one or more sensors, at the second time, at least a portion of the physical characteristics of at least a portion of first vehicles within the at least a portion of the parking facility; and
generate, subject to the capturing and identifying, at the second time, a second augmented reality (AR) representation of the at least a portion of the parking facility and the at least a portion of the first vehicles.

3. The system of claim 1, wherein the autonomous vehicles parking manager is further configured to:
analyze historical data indicating movement patterns of second vehicles within the parking facility; and
present a recommendation whether the one or more autonomous vehicles should be parked in the selected parking location.

4. The system of claim 3, wherein the autonomous vehicles collaboration manager is further configured to:
capture, through the one or more sensors, real time movement of at least a portion of one or more third vehicles through the parking facility.

5. The system of claim 1, wherein the autonomous vehicles parking manager is further configured to:
capture, through the one or more sensors, a real time approach of the one or more autonomous vehicles toward the parking facility.

6. The system of claim 1, wherein the autonomous vehicles parking manager is further configured to:
navigate, at least partially through the AR representation of the at least a portion of the parking facility and the at least a portion of the first vehicles, the one or more autonomous vehicles through the parking facility.

7. The system of claim 6, wherein the autonomous vehicles parking manager is further configured to:
navigate one of autonomously and semi-autonomously.

8. A computer program product to enhance parking of autonomous vehicles comprising:
one or more computer readable storage media; and
program instructions collectively stored on the one or more computer storage media, the program instructions comprising:
program instructions to capture, through one or more sensors, at least a portion of the physical characteristics of a parking facility;
program instructions to identify, through the one or more sensors, at least a portion of the physical characteristics of at least a portion of first vehicles within the at least a portion of the parking facility;
program instructions to generate, subject to the capturing and identifying, an augmented reality (AR) representation of the at least a portion of the parking facility and the at least a portion of the first vehicles;
program instructions to present, through a display device, the AR representation of the at least a portion of the parking facility and the at least a portion of the first vehicles;
program instructions to receive, subject to the presenting, one or more potential parking locations at least partially based on presently vacant parking locations indicated within the AR representation of the at least a portion of the parking facility and the at least a portion of the first vehicles; and
program instructions to park, subject to the receiving, one or more autonomous vehicles within one or more selected parking locations of the one or more potential parking locations.

9. The computer program product of claim 8, further comprising:
program instructions to capture the at least a portion of the physical characteristics of the parking facility, and identify the at least a portion of the physical characteristics of the at least a portion of first vehicles within the at least a portion of the parking facility, at a first time; and
program instructions to generate a first AR representation, at the first time, of the at least a portion of the parking facility and the at least a portion of the first vehicles:
program instructions to capture, through the one or more sensors, at a second time, at least a portion of the physical characteristics of the parking facility;
program instructions to identify, through the one or more sensors, at the second time, at least a portion of the physical characteristics of at least a portion of first vehicles within the at least a portion of the parking facility; and
program instructions to generate, subject to the capturing and identifying, at the second time, a second augmented reality (AR) representation of the at least a portion of the parking facility and the at least a portion of the first vehicles.

10. The computer program product of claim 8, further comprising:
program instructions to analyze historical data indicating movement patterns of second vehicles within the parking facility; and
program instructions to present a recommendation whether the one or more autonomous vehicles should be parked in the selected parking location.

11. The computer program product of claim 10, further comprising:
program instructions to capture, through the one or more sensors, real time movement of at least a portion of one or more third vehicles through the parking facility.

12. The computer program product of claim 8, further comprising:
program instructions to capture, through the one or more sensors, a real time approach of the one or more autonomous vehicles toward the parking facility.

13. The computer program product of claim 8, further comprising:
program instructions to navigate, at least partially through the AR representation of the at least a portion of the parking facility and the at least a portion of the first vehicles, the one or more autonomous vehicles through the parking facility.

14. A computer-implemented method for using augmented reality (AR) to enhance parking of autonomous vehicles comprising:
capturing, through one or more sensors, at least a portion of the physical characteristics of a parking facility;
identifying, through the one or more sensors, at least a portion of the physical characteristics of at least a portion of first vehicles within the at least a portion of the parking facility;
generating, subject to the capturing and identifying, an augmented reality (AR) representation of the at least a portion of the parking facility and the at least a portion of the first vehicles;
presenting, through a display device, the AR representation of the at least a portion of the parking facility and the at least a portion of the first vehicles;
receiving, subject to the presenting, one or more potential parking locations at least partially based on presently vacant parking locations indicated within the AR representation of the at least a portion of the parking facility and the at least a portion of the first vehicles; and
parking, subject to the receiving, one or more autonomous vehicles within one or more selected parking locations of the one or more potential parking locations.

15. The method of claim 14, wherein:
the capturing the at least a portion of the physical characteristics of the parking facility, and the identifying the at least a portion of the physical characteristics of the at least a portion of first vehicles within the at least a portion of the parking facility, are executed at a first time; and
the generating the AR representation of the at least a portion of the parking facility and the at least a portion of the first vehicles comprises:
generating a first AR representation, at the first time, of the at least a portion of the parking facility and the at least a portion of the first vehicles, the method further comprising:
capturing, through the one or more sensors, at a second time, at least a portion of the physical characteristics of the parking facility;
identifying, through the one or more sensors, at the second time, at least a portion of the physical characteristics of at least a portion of first vehicles within the at least a portion of the parking facility; and
generating, subject to the capturing and identifying, at the second time, a second augmented reality (AR) representation of the at least a portion of the parking facility and the at least a portion of the first vehicles.

16. The method of claim 14, further comprising:
analyzing historical data indicating movement patterns of second vehicles within the parking facility; and
presenting a recommendation whether the one or more autonomous vehicles should be parked in the selected parking location.

17. The method of claim 16, further comprising:
capturing, through the one or more sensors, real time movement of at least a portion of one or more third vehicles through the parking facility.

18. The method of claim 14, further comprising:
capturing, through the one or more sensors, a real time approach of the one or more autonomous vehicles toward the parking facility.

19. The method of claim 14, further comprising:
navigating, at least partially through the AR representation of the at least a portion of the parking facility and the at least a portion of the first vehicles, the one or more autonomous vehicles through the parking facility.

20. The method of claim 19, wherein the navigating is executed one of autonomously and semi-autonomously.
